(19) United States
(12) Patent Application Publication
(10) Pub. No.: US 2026/0294709 A1
(43) Pub. Date: Oct. 1, 2026

(54) PATIENT TRANSPORT APPARATUS WITH ARM ASSEMBLY FOR SUPPORTING MEDICAL DEVICES

(71) Applicant: Stryker Corporation, Portage, MI (US)

(72) Inventors: Shawn Trimble, Portage, MI (US); Brandon Joseph Morse, Vicksburg, MI (US); Kevin M. Patmore, Plainwell, MI (US); Ross Timothy Lucas, Paw Paw, MI (US); Ryan Thomas Slusarzyk, Byron Center, MI (US)

(73) Assignee: Stryker Corporation, Portage, MI (US)

(21) Appl. No.: 19/477,089

(22) PCT Filed: Apr. 18, 2024
(86) PCT No.: PCT/US2024/025105

§ 371 Date: Oct. 20, 2025

Related U.S. Application Data
(60) Provisional application No. 63/460,055, filed on Apr. 18, 2023.

(51) Int. Cl. A61G 7/05

(52) U.S. Cl. CPC A61G 7/05

(57) ABSTRACT

A patient support system for concurrently transporting a patient and a medical device with a patient transport apparatus having an intermediate frame. An arm assembly includes a coupler supporting an interface for releasably securing the medical device. A knuckle attached to the intermediate frame, and a carrier supports the coupler for movement between a plurality of arm positions including at least one locked arm position. A linkage is pivotably coupled to the knuckle and the coupler to maintain a predetermined alignment of the coupler relative to the intermediate frame. A selector operatively attached to the linkage supports a shuttle for selective movement between: a locked position to inhibit movement of the coupler relative to the knuckle between the plurality of arm positions from the at least one locked arm position, and a disengaged position to permit movement of the coupler relative to the knuckle between the plurality of arm positions.

### CROSS-REFERENCE TO RELATED APPLICATIONS

This application claims priority to U.S. Provisional Patent Application No. 63/460,055 filed Apr. 18, 2023, which is incorporated herein by reference in its entirety.

### BACKGROUND

Patient transport apparatuses, such as hospital beds, stretchers, cots, tables, wheelchairs, and chairs facilitate care and transportation of patients. Conventional patient transport apparatuses comprise a base, lift mechanism, and a litter comprising a patient support surface upon which the patient is supported.

In certain situations (such as first response scenarios) caregivers must travel to the patient and transport the patient back to an emergency medical facility. Depending on the scenario, caregivers may also require the use of various types of medical devices (e.g. a heart monitor, a defibrillator, and the like) to facilitate the care of the patient. Here, the medical device typically is separate from the patient transport apparatus and is moved concurrently with the patient transport apparatus during patient care. The separate nature of the patient transport apparatus and the medical device requires the caregivers to expend effort and attention to associate the medical device with the patient supported on the patient transport apparatus, as well as to manipulate, handle, or otherwise utilize the medical device to facilitate patient care during transport.

Those having ordinary skill in the art will appreciate that transit of the patient to hospitals or other medical facilities in cargo areas of ambulances or similar vehicles can present potential risk of danger to the patient and/or to caregivers if the medical device is not properly secured. For example, a vehicular crash involving the ambulance could result in an unsecured medical device moving unexpectedly throughout the cargo area of the ambulance.

There remains a need in the art to improve the safety, usability, and ergonomics associated with utilizing medical devices which are transported concurrently with patient transport apparatuses.

### SUMMARY

The present disclosure provides a patient support system for concurrently transporting a patient and a medical device, including: a patient transport apparatus including a base arranged for movement along floor surfaces, and an intermediate frame coupled to the base and defining a patient support deck; and an arm assembly including: a coupler supporting an interface for releasably securing the medical device, a knuckle operatively attached to the intermediate frame of the patient transport apparatus and defining at least one receiver, and a carrier supporting the coupler for movement relative to the knuckle between a plurality of arm positions including at least one locked arm position, the carrier including: a linkage pivotably coupled to the knuckle and to the coupler to maintain a predetermined alignment of the coupler relative to the intermediate frame between the plurality of arm positions, and a selector operatively attached to the linkage and supporting a shuttle for selective movement between: a locked shuttle position disposed in engagement with the at least one receiver to inhibit movement of the coupler relative to the knuckle between the plurality of arm positions from the at least one locked arm position; and a disengaged shuttle position spaced from the at least one receiver to permit movement of the coupler relative to the knuckle between the plurality of arm positions from the at least one locked arm position.

The present disclosure also provides an arm assembly for use in securing a medical device for concurrent movement with a patient transport apparatus, including: a coupler supporting an interface for releasably securing the medical device; a knuckle for attaching to the patient transport apparatus, the knuckle defining at least one receiver; and a carrier supporting the coupler for movement relative to the knuckle between a plurality of arm positions including at least one locked arm position, the carrier including: a linkage pivotably coupled to the knuckle and to the coupler to maintain a predetermined alignment of the coupler relative to the patient transport apparatus between the plurality of arm positions, and a selector operatively attached to the linkage and supporting a shuttle for selective movement between: a locked shuttle position disposed in engagement with the at least one receiver to inhibit movement of the coupler relative to the knuckle between the plurality of arm positions from the at least one locked arm position; and a disengaged shuttle position spaced from the at least one receiver to permit movement of the coupler relative to the knuckle between the plurality of arm positions from the at least one locked arm position.

The present disclosure also provides a patient support system for concurrently transporting a patient and a medical device, including: a patient transport apparatus including a base arranged for movement along floor surfaces, and an intermediate frame coupled to the base and defining a patient support deck; and an arm assembly including: a coupler supporting an interface for releasably securing the medical device, a knuckle operatively attached to the intermediate frame of the patient transport apparatus and defining at least one receiver and at least one notch spaced from the at least one receiver, and a carrier supporting the coupler for movement relative to the knuckle between a plurality of arm positions including at least one locked arm position and at least one catch arm position, the carrier including: a linkage pivotably coupled to the knuckle and to the coupler to maintain a predetermined alignment of the coupler relative to the intermediate frame between the plurality of arm positions, and a selector operatively attached to the linkage and supporting a shuttle for selective movement between: a locked shuttle position disposed in engagement with the at least one receiver to inhibit movement of the coupler relative to the knuckle between the plurality of arm positions from the at least one locked arm position; a disengaged shuttle position spaced from the at least one receiver to permit movement of the coupler relative to the knuckle between the plurality of arm positions from the at least one locked arm position; and a catch shuttle position disposed in engagement with the at least one notch to limit movement of the coupler relative to the knuckle by simultaneously: inhibiting movement of the coupler relative to the knuckle from the at least one catch arm position in a block direction away from the at least one locked arm position, and permitting movement of the coupler relative to the knuckle from the at least one catch arm position in a permit direction, opposite to the block direction, towards the at least one locked arm position.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a perspective view of a patient support system including a patient transport apparatus with an arm assembly for releasably securing a medical device according to versions of the present disclosure, the arm assembly shown supporting the medical device in a first locked arm position.

FIG. 2A is another perspective view of the patient support system of FIG. 1, shown with the medical device having been rotated about an interface of the arm assembly.

FIG. 2B is another perspective view of the patient support system of FIG. 2A, shown with the medical device having been released from the interface of the arm assembly.

FIG. 3A is a left side plan view of the patient support system of FIG. 1, shown with the arm assembly supporting the medical device in a stowed arm position.

FIG. 3B is another left side plan view of the patient support system of FIG. 3A, shown with the arm assembly supporting the medical device in a safety catch arm position.

FIG. 3C is another left side plan view of the patient support system of FIGS. 3A-3B, shown with the arm assembly supporting the medical device in the first locked arm position.

FIG. 3D is another left side plan view of the patient support system of FIGS. 3A-3C, shown with the arm assembly supporting the medical device in a second locked arm position.

FIG. 3E is another left side plan view of the patient support system of FIGS. 3A-3D, shown with the arm assembly supporting the medical device in a third locked arm position.

FIG. 3F is another left side plan view of the patient support system of FIGS. 3A-3E, shown with the arm assembly supporting the medical device in a transfer catch arm position.

FIG. 4A is a partially-exploded perspective view of the arm assembly of the patient support system of FIGS. 1-3F, shown with the interface spaced from a coupler of the arm assembly.

FIG. 4B is another exploded perspective view of the arm assembly of FIG. 4A, shown including a knuckle with a plurality of receivers and a plurality of notches, and a carrier having a linkage, a selector, a shuttle, and a user interface.

FIG. 5 is a top side plan view of portions of the arm assembly of FIGS. 1-4B, shown arranged in the first locked arm position.

FIG. 6 is a perspective view of the portions of the arm assembly of FIG. 5 shown in section taken along line 6-6 in FIG. 5.

FIG. 7A is a sectional view of portions of the arm assembly taken along line 6-6 in FIG. 5 depicted with the arm assembly arranged in the stowed arm position of FIG. 3A, and with the shuttle shown engaging a seat of the knuckle.

FIG. 7B is a sectional view of portions of the arm assembly taken along line 6-6 in FIG. 5 depicted with the arm assembly arranged in the safety catch arm position of FIG. 3B, and with the shuttle shown engaging a first one of the notches of the knuckle.

FIG. 7C is a sectional view of portions of the arm assembly taken along line 6-6 in FIG. 5 depicted with the arm assembly arranged in the first locked arm position of FIG. 3C, and with the shuttle shown engaging a first one of the receivers of the knuckle.

FIG. 7D is a sectional view of portions of the arm assembly taken along line 6-6 in FIG. 5 depicted with the arm assembly arranged in the second locked arm position of FIG. 3D, and with the shuttle shown engaging a second one of the receivers of the knuckle.

FIG. 7E is a sectional view of portions of the arm assembly taken along line 6-6 in FIG. 5 depicted with the arm assembly arranged in the third locked arm position of FIG. 3E, and with the shuttle shown engaging a third one of the receivers of the knuckle.

FIG. 7F is a sectional view of portions of the arm assembly taken along line 6-6 in FIG. 5 depicted with the arm assembly arranged in the transfer catch arm position of FIG. 3F, and with the shuttle shown engaging a second one of the notches of the knuckle.

FIG. 8A is another sectional view of the portions of the arm assembly of FIG. 7F, shown arranged in the transfer catch arm position of FIG. 3F to illustrate movement of the arm assembly in response to force applied by a user.

FIG. 8B is another sectional view of the portions of the arm assembly of FIG. 8A, shown with the arm assembly arranged between the transfer catch arm position of FIG. 3F and the third locked arm position of FIG. 3E to illustrate movement of the arm assembly out of the transfer catch arm position in response to force applied by a user.

FIG. 8C is another sectional view of the portions of the arm assembly of FIG. 8B, shown arranged in the third locked arm position of FIG. 3E to illustrate movement of the arm assembly into the third locked arm position.

FIG. 9A is another sectional view of the portions of the arm assembly of FIG. 7E, shown arranged in the third locked arm position of FIG. 3E to illustrate movement of the arm assembly in response to engagement of the user interface.

FIG. 9B is another sectional view of the portions of the arm assembly of FIG. 9A, shown with the shuttle having moved out of engagement with the third one of the receivers in response to user engagement of the user interface.

FIG. 9C is another sectional view of the portions of the arm assembly of FIG. 9C, shown having moved towards the second locked arm position of FIG. 3D and with the shuttle disposed adjacent to the second one of the receivers.

FIG. 9D is another sectional view of the portions of the arm assembly of FIG. 9C, shown arranged in the second locked arm position of FIG. 3D to illustrate movement of the arm assembly into the second locked arm position following user engagement with the user interface.

FIG. 10A is a sectional view of portions of another configuration of the arm assembly according to the present disclosure.

FIG. 10B is a detail view of the sectional view of FIG. 10A.

FIG. 10C is a perspective view of the portions of the arm assembly of FIG. 10A.

### DETAILED DESCRIPTION

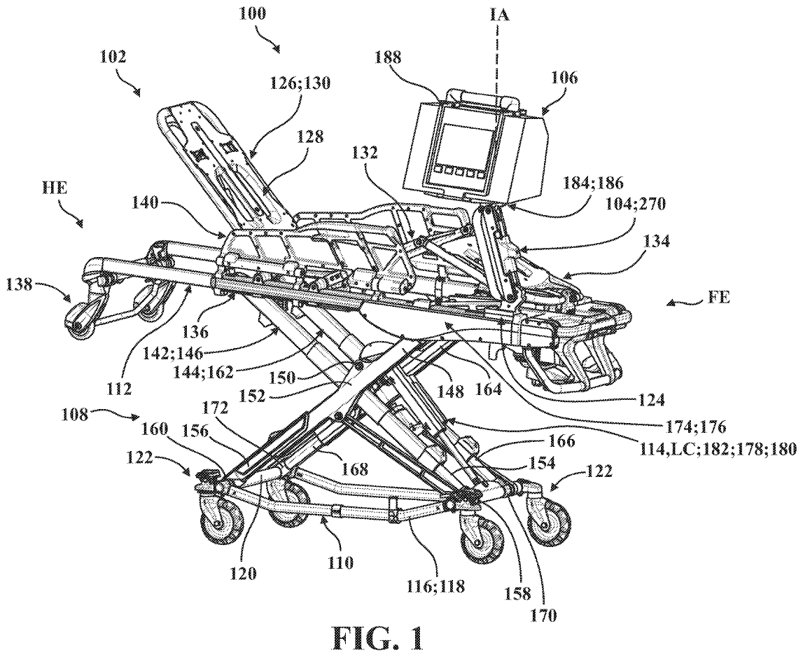

Referring to FIGS. 1-3F, a patient support system 100 is shown. The patient support system 100 generally includes a patient transport apparatus 102 and an arm assembly 104 coupled to the patient transport apparatus 102 and configured to releasably secure a medical device 106 to facilitate care of a patient supported on the patient transport apparatus 102. The various components of the patient support system 100 will each be described in greater detail below.

The patient transport apparatus 102 is configured for supporting the patient in a health care and/or transportation setting. The representative version of the patient transport apparatus 102 illustrated in FIGS. 1-3B is realized as a cot. In other versions, however, aspects of the present disclosure could be utilized where the patient transport apparatus 102 is realized as a hospital bed, stretcher, table, wheelchair, chair, or similar apparatus utilized in the transportation and care of a patient.

The patient transport apparatus 102 generally defines a head end HE and a foot end FE spaced longitudinally from the head end HE, and includes or otherwise defines a support structure 108 to provide support for the patient and facilitate transport. The support structure 108 generally comprises a base 110, a litter 112, and a lift mechanism 114 to move the litter 112 relative to the base 110 as described in greater detail below. In some versions, the base 110 may include a base frame 116 comprising longitudinal rails 118 and lateral rails 120 interconnected at ends thereof to the longitudinal rails 118 to form a generally rectangular profile. A plurality of caster wheel assemblies 122 are operatively attached to the base 110 adjacent to each corner defined by the rails 118, 120 of the base frame 116. The wheel assemblies 122 may be configured to swivel to facilitate turning or otherwise maneuvering the patient transport apparatus 102. One or more of the wheel assemblies 122 may comprise a swivel locking mechanism (not shown) to prevent the wheel assembly 122 from swiveling when engaged. The wheel assembly 122 may also comprise a wheel brake (not shown) to prevent rotation of the wheel. Other configurations are contemplated.

The litter 112 of the support structure 108 generally comprises an intermediate frame 124 to which a patient support deck 126 is operatively attached or otherwise defined. Here, the patient support deck 126 generally defines a patient support surface 128 configured to support the patient, and comprises various deck sections such as a back section 130, a seat section 132, a leg or foot section 134, and the like which may be articulable relative to each other and/or relative to the intermediate frame 124 to facilitate positioning the patient in different positions. In some versions, a mattress (not shown) may be provided on the patient support deck 126 to define a secondary patient support surface. The intermediate frame 124 of the litter 112 may comprise hollow side rails 136 that extend longitudinally along the patient support surface 128. The litter 112 may further comprise or otherwise support loading wheels 138 extending from the intermediate frame 124 proximate the back section 130 to facilitate loading and unloading of the patient transport apparatus 102 from a vehicle. For example, the loading wheels 138 may be positioned and configured to facilitate loading and unloading the patient transport apparatus 102 into an ambulance.

Hand rails 140 may extend from opposing sides of the intermediate frame 124 to provide egress barriers for the patient on the patient support surface 128. The hand rails 140 may also be utilized by a caregiver, such as an emergency medical technician (EMT) or other medical professional, to move or manipulate the patient transport apparatus 102. The hand rails 140 may comprise a hinge, pivot, or similar mechanism to allow the rails 140 to be folded or stored at or below the plane of the patient support surface 128.

As noted above, the lift mechanism 114 is provided to facilitate arranging the litter 112 relative to the base 110. More specifically, the lift mechanism 114 is configured to move the litter 112 relative to the base 110 between a plurality of lift configurations LC (not shown in detail) including a fully-extended configuration, a fully-retracted configuration, and one or more transport configurations between the fully-extended configuration and the fully-retracted configuration. In the representative version illustrated herein, the lift mechanism 114 interconnects the base 110 and the litter 112 to facilitate raising and lowering of the litter 112 relative to a transport surface (e.g., a floor surface).

The lift mechanism 114 may be manipulated to adjust the height of the litter 112 as described in greater detail below. While moving between the plurality of lift configurations LC, the lift mechanism 114 may move either the base 110 or the litter 112 relative to the other of the litter 112 or the base 110 depending on how the patient transport apparatus 102 is supported during use. For instance, the patient transport apparatus 102 may be supported at the base 110 on the ground, such as during transport to and from an ambulance, an incident scene, and the like. In other instances, the patient transport apparatus 102 may be supported at the litter 112, such as when the patient transport apparatus 102 is being unloaded/loaded into an ambulance. In instances where the patient transport apparatus 102 is supported at the litter 112, the lift mechanism 114, while moving between the plurality of lift configurations LC, moves the base 110 relative to the litter 112. In instances where the patient transport apparatus 102 is supported at the base 110, while moving between the plurality of lift configurations LC, the lift mechanism 114 moves the litter 112 relative to the base 110.

In the illustrated version, the lift mechanism 114 includes side-by-side oriented first and second “X” frame assemblies 142, 144. The first frame assembly 142 comprises first and second left-side upper frame members 146, 148 interconnected together adjacent to their midpoints via a pivot axle 150 extending through a bracket 152. In the illustrated version, the first and second left-side upper frame members 146, 148 are each hollow and telescopingly receive therein respective first and second left-side lower frame members 154, 156, which are supported for movement into and out of the respective first and second left-side upper frame members 146, 148. As is best shown in FIG. 1, the distal end of the first left-side lower frame member 154 is secured via a first left-side connection 158 to the lateral rail 120 at the left-side foot end of the base 110, and the distal end of the second left-side lower frame member 156 is connected via a second left-side connection 160 to the lateral rail 120 at the right-side head end of the base 110.

The second frame assembly 144 is similarly constructed, and comprises first and second right-side upper frame members 162, 164 interconnected together adjacent to their midpoints via the pivot axle 150 extending through another bracket 152. While the axle 150 is illustrated to extend laterally between the first and second frame assemblies 142, 144, it is to be understood that separate axles 24 can, if desired, be employed. Here too, the first and second right-side upper frame members 162, 164 are each hollow and telescopingly receive therein respective first and second right-side lower frame members 166, 168, which are supported for movement into and out of the respective first and second right-side upper frame members 162, 164. The distal end of the first right-side lower frame member 166 is secured via a first right-side connection 170 to the lateral rail 120 at the right-side foot end of the base 110, and the distal end of the second right-side lower frame member 168 is connected via a second right-side connection 172 to the lateral rail 120 at the right-side head end of the base 110. While the patient transport apparatus 102 illustrated throughout the drawings comprises a support structure 108 with a lift mechanism 114 comprising first and second frame assemblies 142, 144, it will be appreciated that other configurations are contemplated, and the patient transport apparatus 102 may comprise a support structure 108 and base 110 with a pair of front and rear folding leg members in some versions (e.g., realized as a “roll-in cot”).

The proximal ends of the second left-side upper frame member 148 and the second right-side upper frame member 164 are slidably engaged with respective brackets 174 (only one shown) attached to the underside of the side rails 136 of the intermediate frame 124. Each bracket 174 comprises a respective slot or track 176 configured to allow the proximal ends P of the second left-side upper frame member 148 and the second right-side upper frame member 164 to travel along the tracks 176 as the lift mechanism 114 is manipulated move the litter 112 relative to the base 110 between the plurality of lift configurations LC. The configuration or shape of the track 176 may be configured to orient the litter 112 at a particular angle as the lift mechanism 114 is raised and/or lowered. For example, the track 176 may be configured to be straight, or it may comprise one or more bends or curves, creating an S-like shape. In some versions, the shape of track 176 may be configured to keep the litter 112 approximately level as the litter 112 is raised or lowered between certain lift configurations LC. The track 176 may also be configured to tilt or angle the patient support surface 128 of the litter 112 so that either the head or leg end of the litter 112 is elevated relative to the opposing end of the litter 112 in certain lift configurations LC. For example, the track 176 may be configured to elevate the head end of the patient support surface 128 when raised to the fully-extended configuration to assist in loading and unloading the patient transport apparatus 102 in a vehicle.

In the representative version illustrated herein, the patient transport apparatus 102 employs a control system 178 with a controller 180 (see FIG. 1; depicted schematically alongside actuator 182) to effect operation of the lift mechanism 114 by, among other things, driving one or more actuators 182 (see FIG. 1) configured to manipulate the first and second frame assemblies 142, 144 to move the litter 112 relative to the base 110 between the lift configurations LC. In the illustrated version, the actuator 182 is realized as a hydraulic linear actuator which is connected to and extends between the base 110 and the litter 112. While a single, hydraulically-actuated, linear actuator 182 is employed in the representative version illustrated herein, those having ordinary skill in the art will appreciate that actuators 182 of various styles, types, and/or configurations could be utilized without departing from the scope of the present disclosure. By way of non-limiting example, one or more linear and/or rotary actuators 182 could be utilized in some versions, one or more of which could be driven via the control system 178 using various combinations of electrical, hydraulic, and/or pneumatic components, systems, and the like. Other configurations are contemplated. The Applicant has described versions of similar lift mechanisms 114 in U.S. Pat. No. 7,398,571 entitled “Ambulance Cot and Hydraulic Elevating Mechanism Therefor,” U.S. Patent Application Publication No. 2018/0303689 A1 entitled “Emergency Cot With a Litter Height Adjustment Mechanism,” and U.S. Patent Application Publication No. 2018/0303685 A1 entitled “Patient Handling Apparatus with Hydraulic Control System,” the disclosures of each of which are hereby incorporated by reference in their entirety. However, as noted above, other configurations are contemplated.

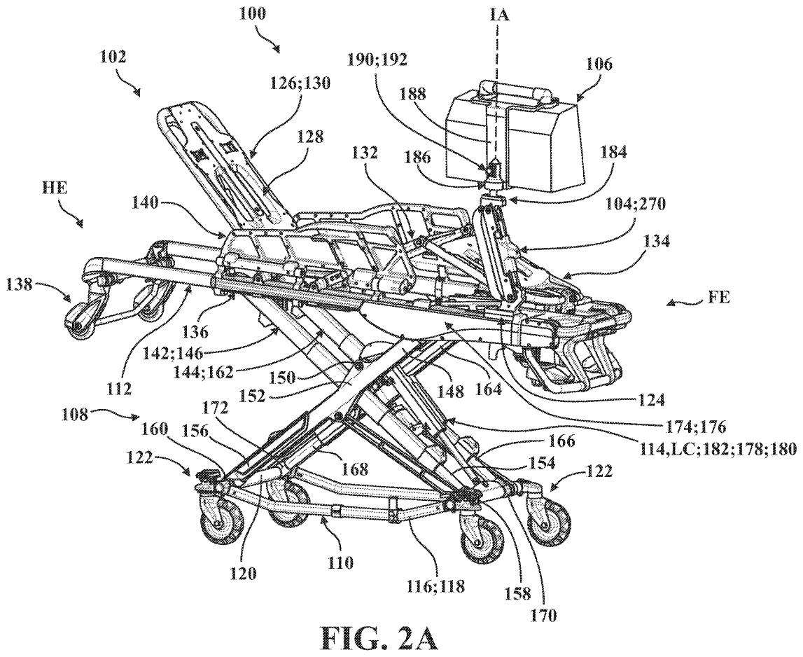

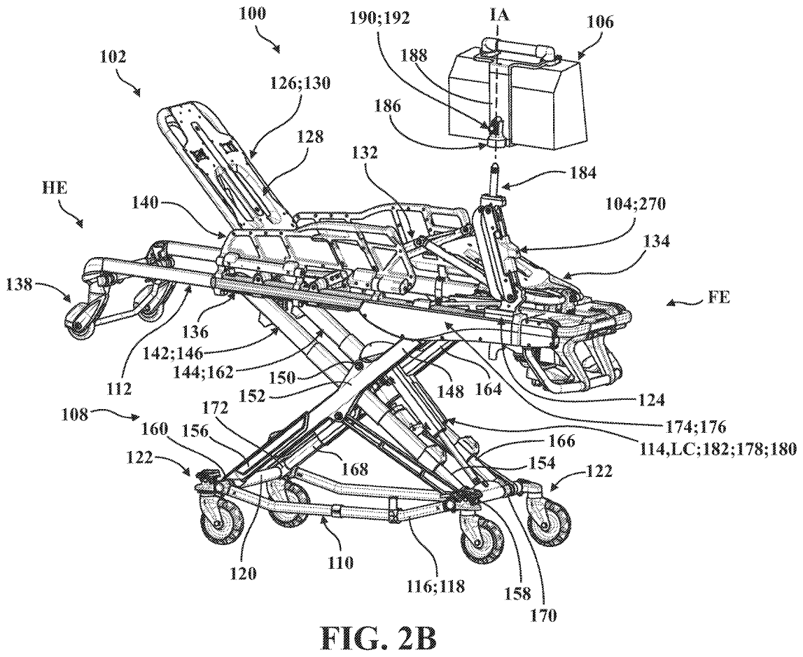

Referring now to FIGS. 1-2B, as noted above, the patient support system 100 is configured for concurrently transporting the patient and the medical device 106 together with the patient transport apparatus 102 via the releasable connection of the medical device 106 to the arm assembly 104 which, in turn, is operatively attached to the intermediate frame 124 of the patient transport apparatus 102 as described in greater detail below. In some versions, the medical device 106 may be realized as a heart monitor, an automated defibrillator (AED), or any other suitable type of medical device 106 utilized in connection with patient care.

In the illustrated version, the arm assembly 104 includes an interface 184 that is configured to releasably secure the medical device 106 to the arm assembly 104 for concurrent movement with the patient transport apparatus 102. To this end, the medical device 106 includes or otherwise defines a mount 186 configured for releasable attachment to the interface 184 of the arm assembly 104. As is best depicted in FIG. 2B, the mount 186 is operatively attached to an equipment frame 188 which, in turn, secures or otherwise supports the medical device 106. The dimensions and configuration of the equipment frame 188 may generally correspond to the structural arrangement of the medical device 106 (e.g., shaped and arranged to permit access to ports, controls, displays, connections, buttons, and the like of the medical device 106; not shown in detail). In some versions, the mount 186 may be formed as a part of the medical device 106 (e.g., without the use of the equipment frame 188). Other configurations are contemplated.

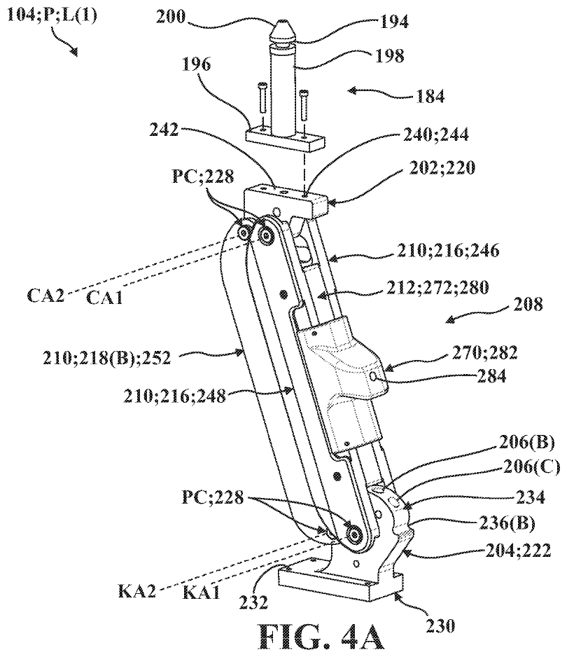

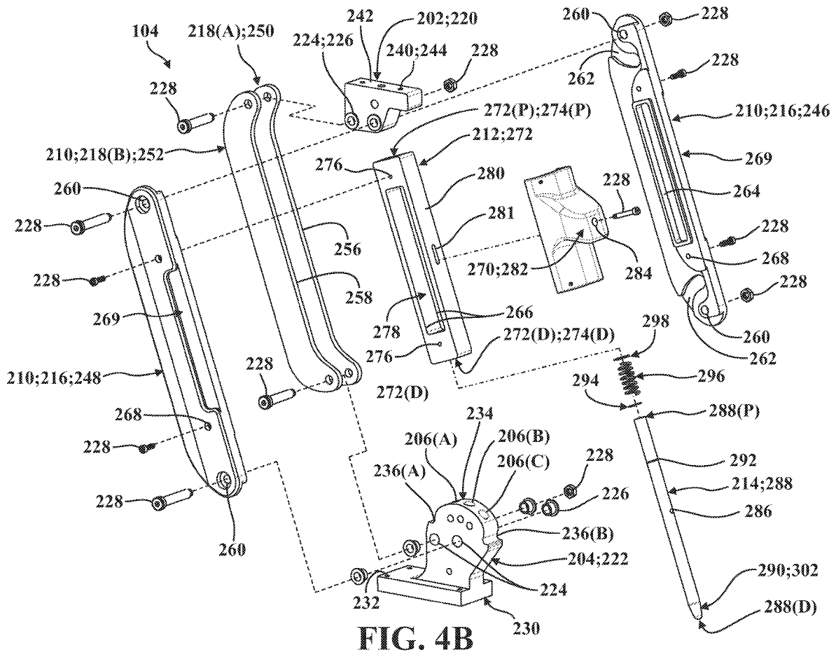

A release mechanism 190 is disposed adjacent to the mount 186 of the equipment frame 188, and includes a release input 192 arranged for user engagement to facilitate releasably securing the medical device 106 to the arm assembly 104. While not shown in detail herein, the release mechanism 190 is configured to engage a lock element 194 of the interface 184 to inhibit relative movement between the interface 184 and the mount 186 during an absence of user engagement with the release input 192. Put differently, when the interface 184 and the mount 186 are secured together, engagement occurring between the release mechanism 190 and the lock element 194 inhibits movement of the mount 186 relative to the interface 184 in multiple degrees of freedom (e.g., three translational degrees of freedom and three rotational degrees of freedom). In the illustrated version, the interface 184 includes a base plate 196 from which a rod 198 extends towards a tapered cap 200 adjacent to the lock element 194 (see FIG. 4A; not shown in detail).

The tapered cap 200 and the mount 186 have correspondingly-shaped profiles that help facilitate releasable attachment of the medical device 106 to the arm assembly 104 along an interface axis IA (compare FIGS. 2A-2B). Here, the caregiver can engage the release input 192 to operate the release mechanism 190 to facilitate detaching the medical device 106 from the arm assembly 104. It will be appreciated that the release mechanism 190 and/or the lock element 194 may configured in various ways so as to releasably engage together in order to inhibit relative movement between the mount 186 and the interface 184 from one or more predetermined arrangements, orientations, and the like. Put differently, the interface 184 may be configured to facilitate rotation of the medical device 106 relative to the arm assembly 104 (e.g., about the interface axis IA; compare FIGS. 1-2A) in order to allow a caregiver to select a rotational position, orientation, and the like of the medical device 106 relative to the arm assembly 104. By way of non-limiting example, and while not illustrated in detail throughout the drawings, the release mechanism 190 may include a biased plunger that engages in one or more discrete plunger catches defining the lock element 194 to secure the medical device 106 to the arm assembly 104. Other configurations are contemplated.

In some versions, releasable attachment between the medical device 106 and the interface 184 could be similar to as is described in U.S. Patent Application Publication No. 2022/0304760 A1 entitled “Patient Support Apparatus With Support Assembly For Medical Device,” the disclosure of which is hereby incorporated by reference in its entirety. However, as will be appreciated from the subsequent description below, the interface 184 of the arm assembly 104 may be configured in a number of different ways sufficient to facilitate releasably securing the medical device 106 to the arm assembly 104 without departing from the scope of the present disclosure. Moreover, while the version of the interface 184 illustrated throughout the drawings is configured to facilitate releasable attachment of the medical device 106 by moving the mount 186 out of engagement with the tapered cap 200 along the interface axis IA in a generally vertical direction once the release input 192 has been engaged by the caregiver, other directions of motion are contemplated (e.g., movement in lateral and/or longitudinal directions, movement in other directions, compound movement in multiple directions, and the like). Similarly, it will be appreciated that the release mechanism 190 could be configured in various ways to facilitate releasable attachment of the medical device 106 and/or to facilitate user selectable orientation, rotation, and the like of the medical device 106 in various directions (e.g., to facilitate one or more of rotation, panning, tilt, and the like). In addition, it will be appreciated that the same mechanism could be used to facilitate releasable attachment and user selected rotation of the medical device 106, or separate mechanisms could be employed (e.g., one to facilitate releasable attachment and another to facilitate user selected rotation), using various arrangements of components realized as a part of the arm assembly 104 (e.g., a portion of the interface 184) and/or realized as a part of the medical device 106 (e.g., a portion of the equipment frame 188, the mount 186, and the like). Other configurations are contemplated.

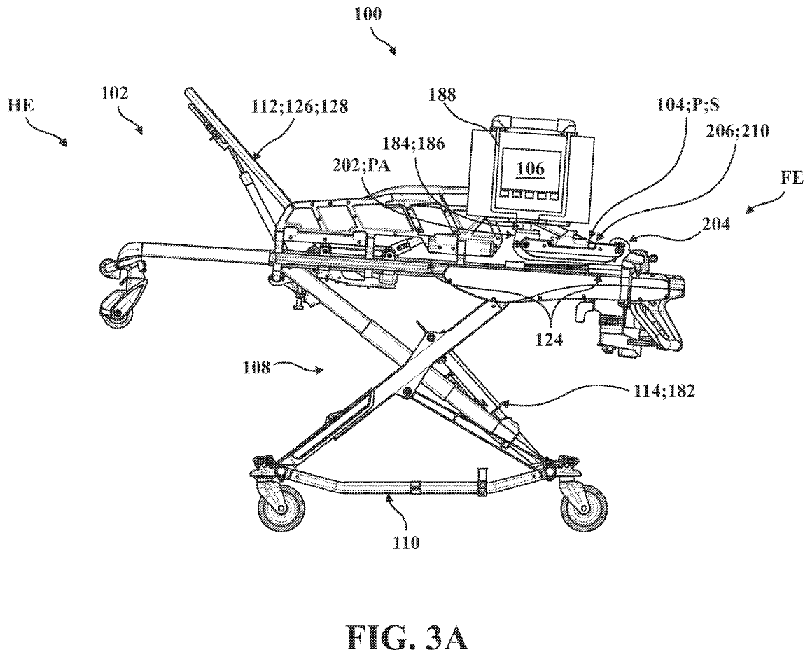

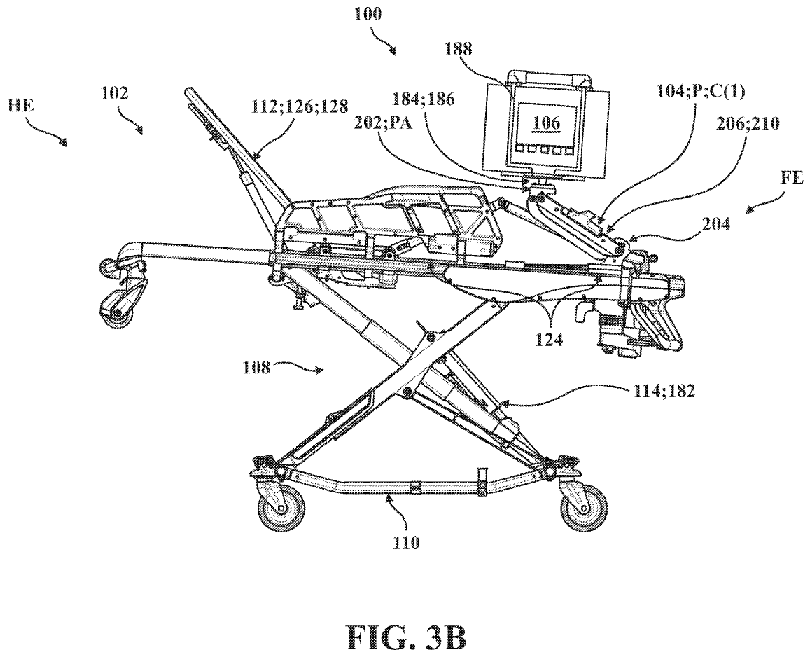

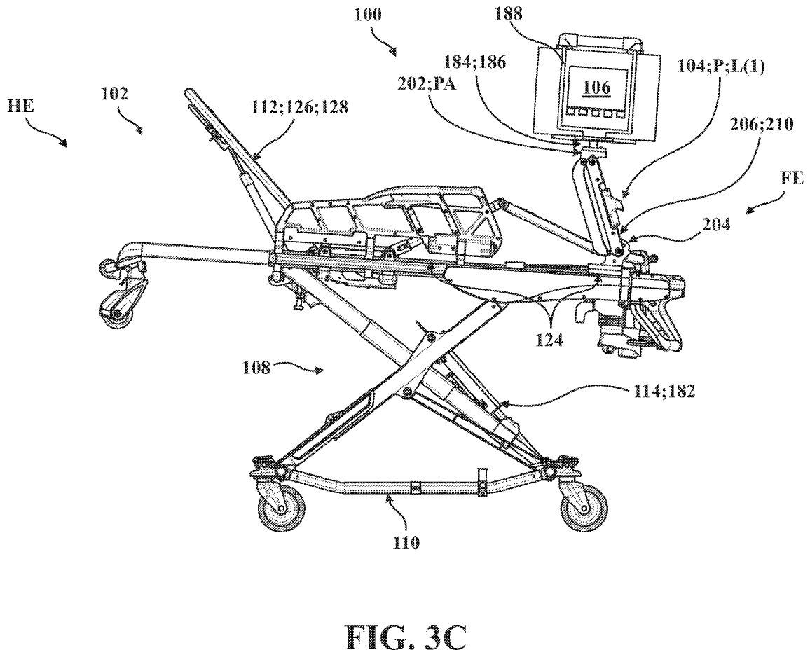

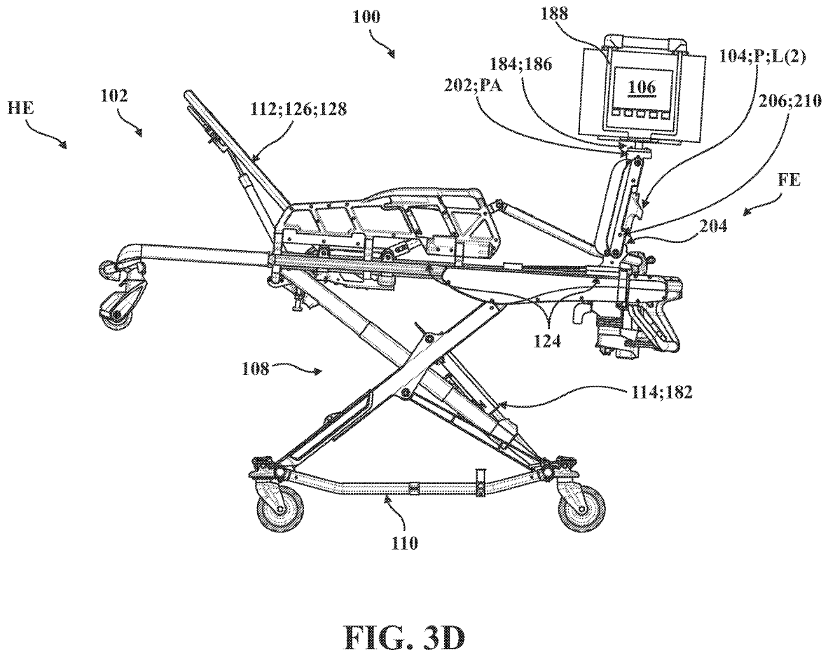

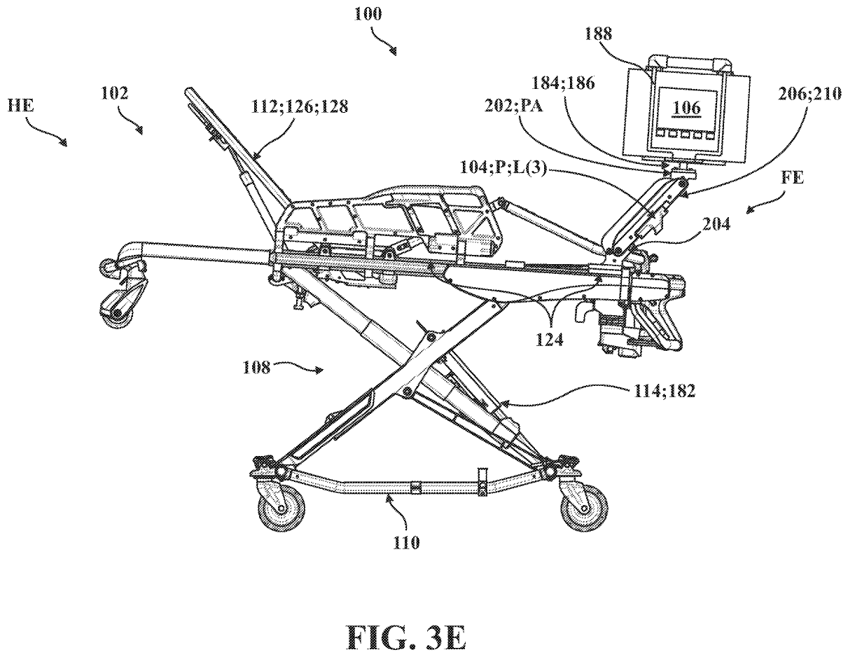

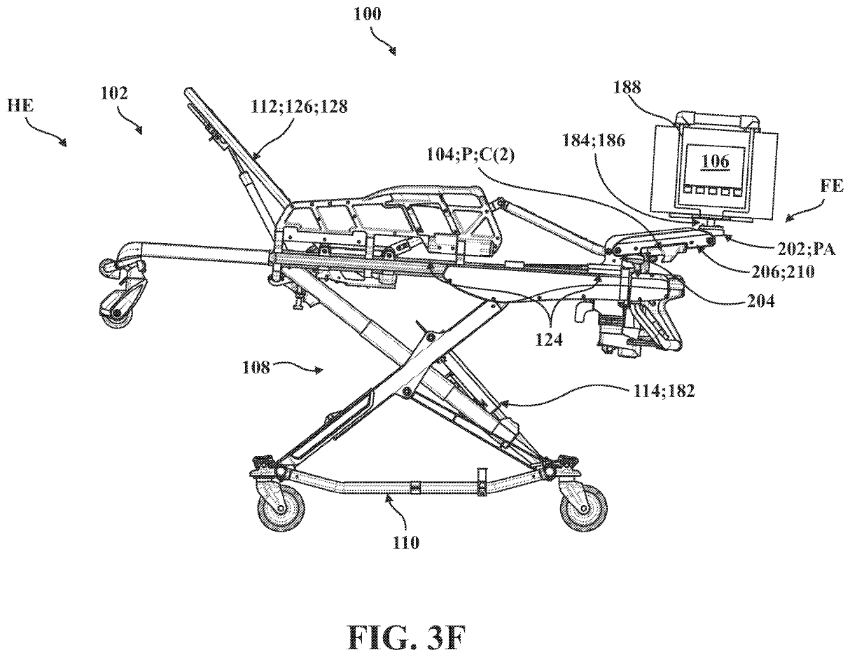

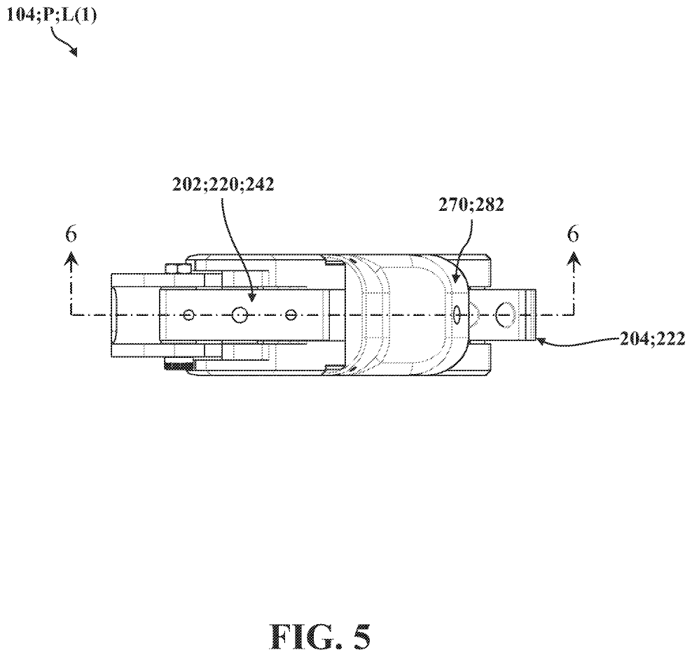

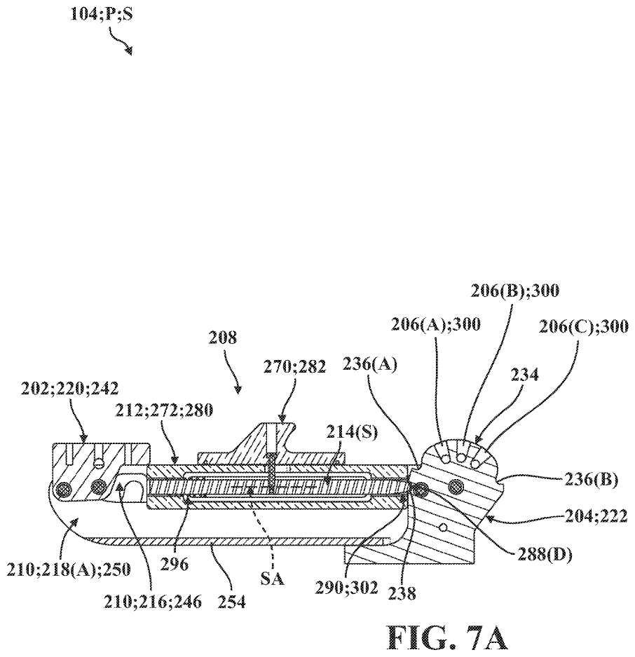

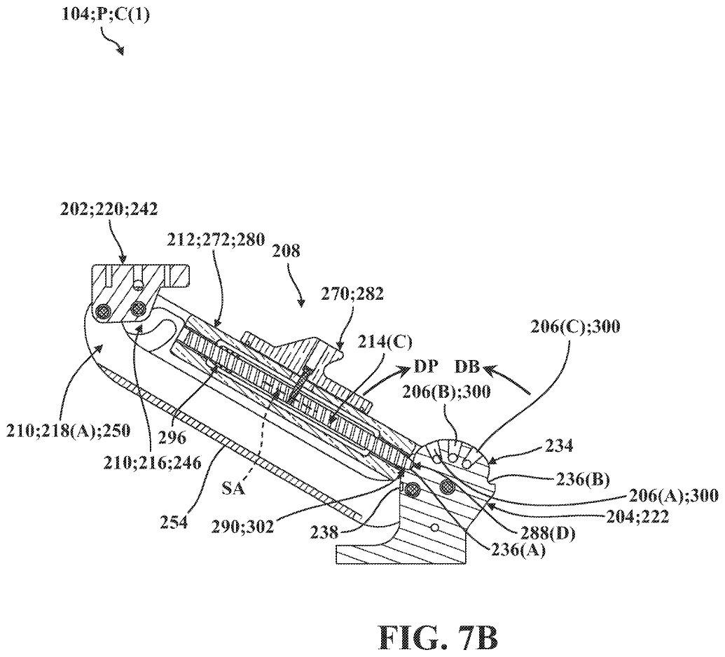

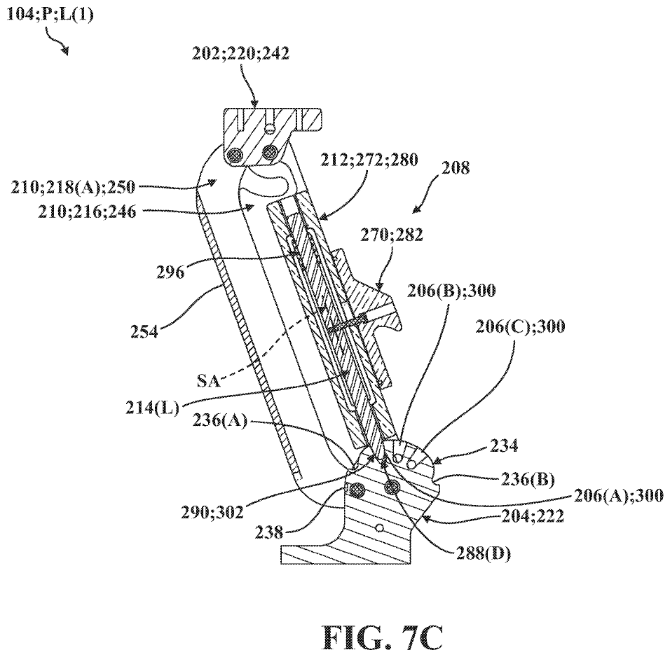

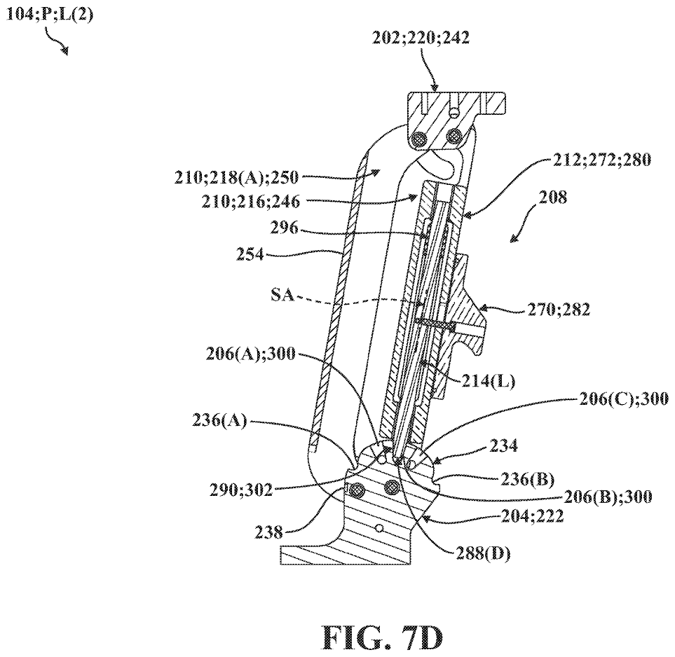

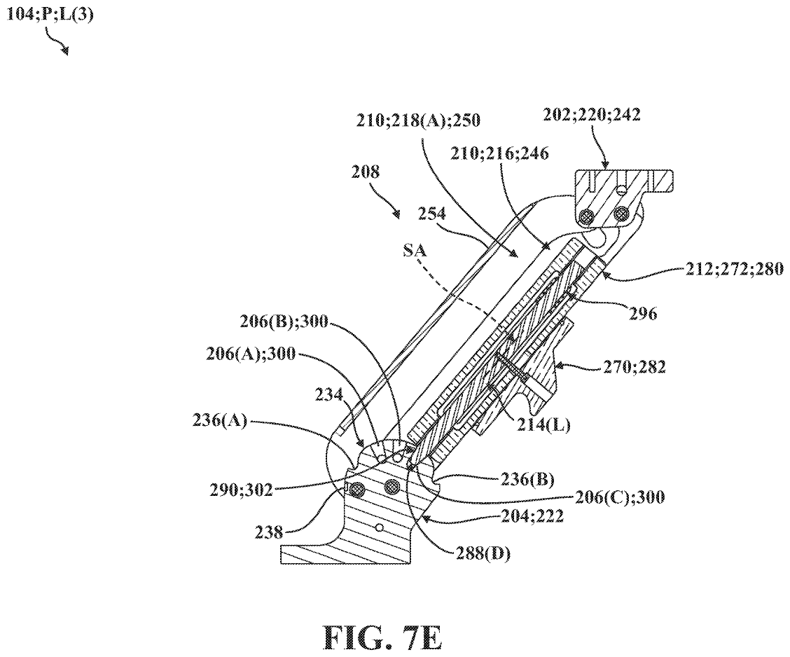

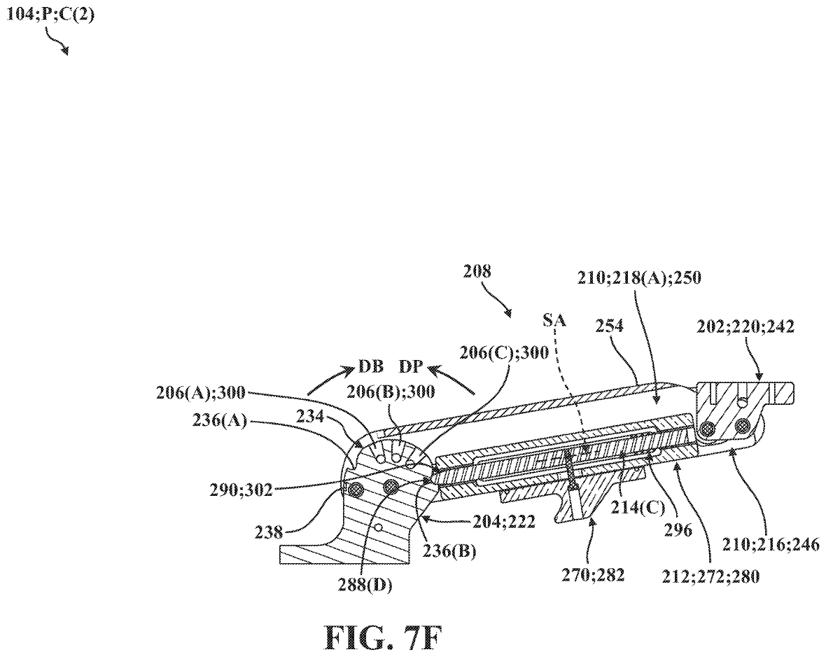

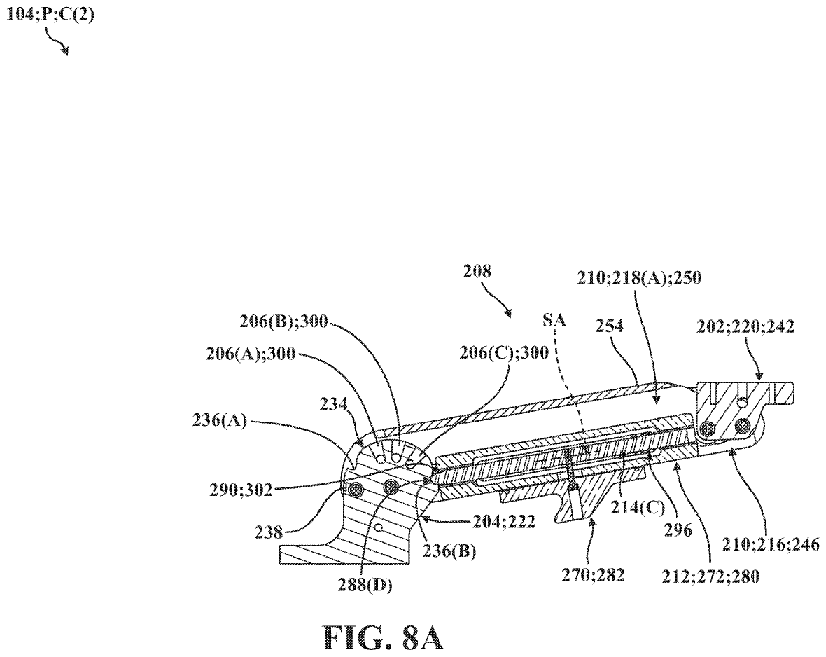

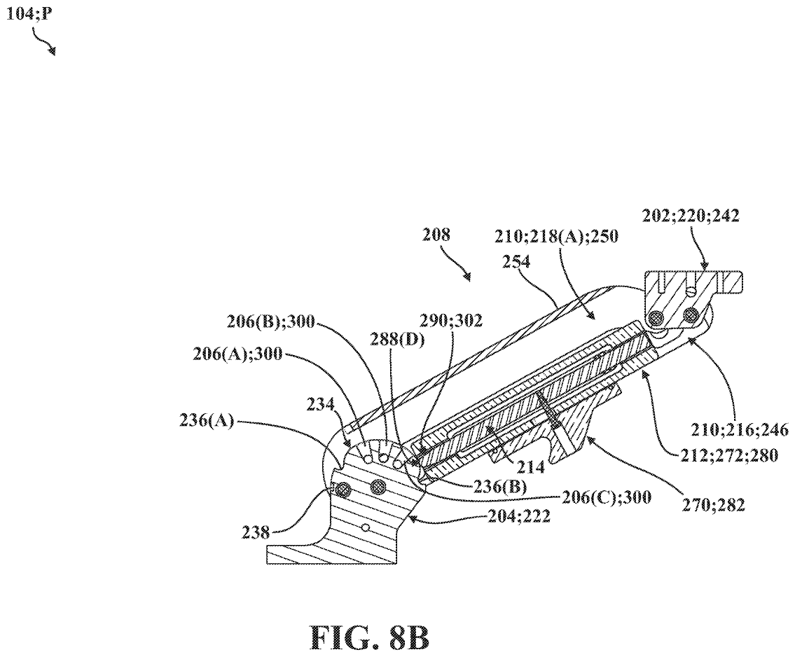

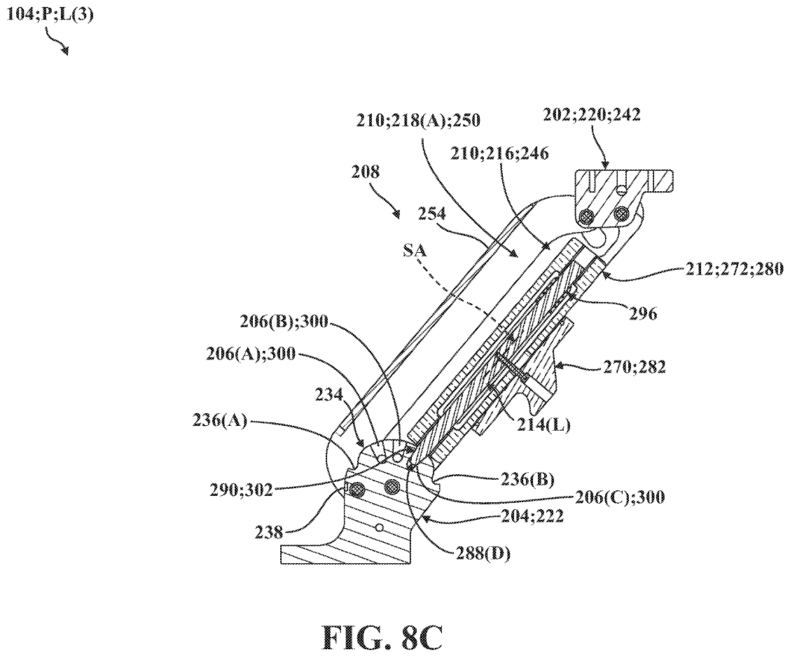

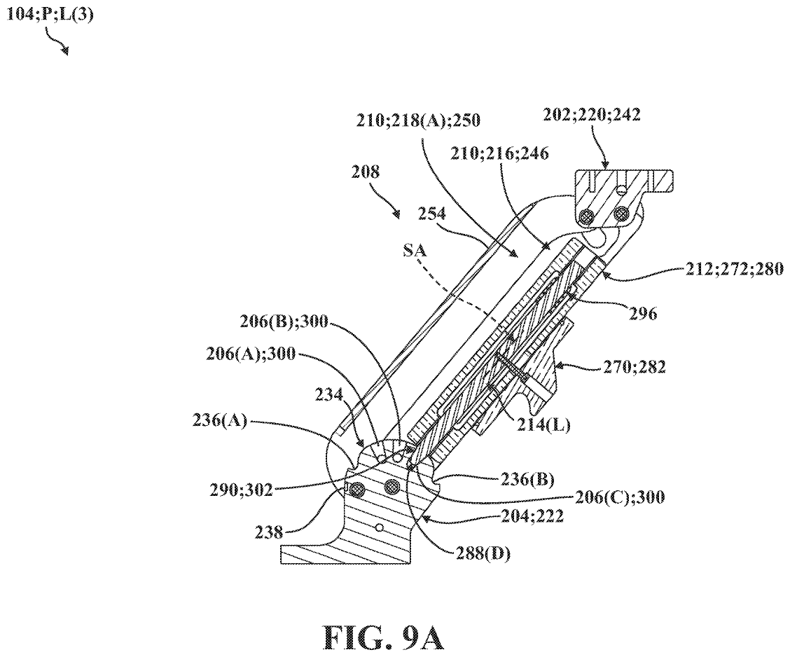

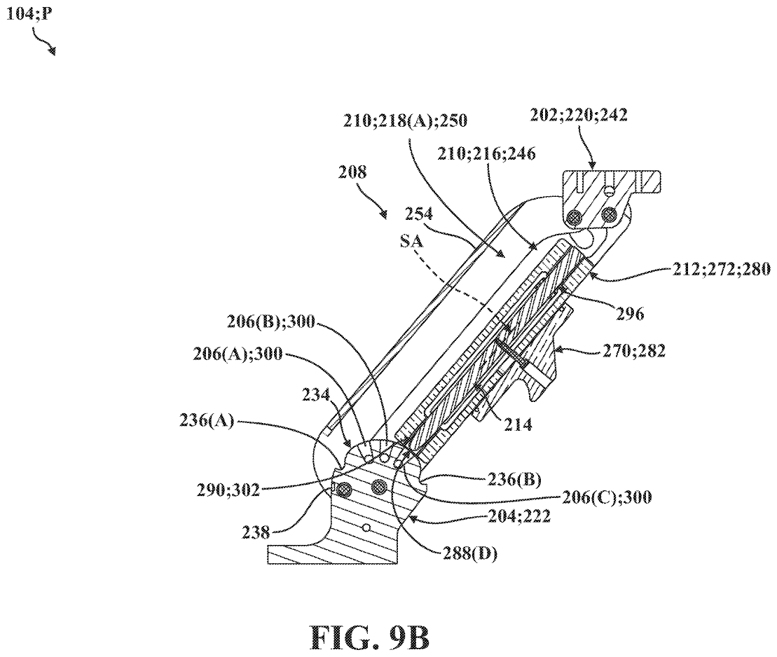

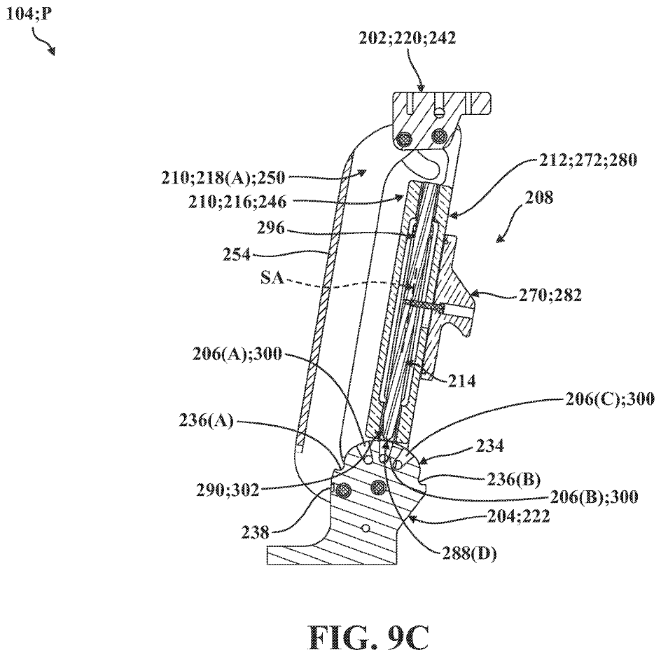

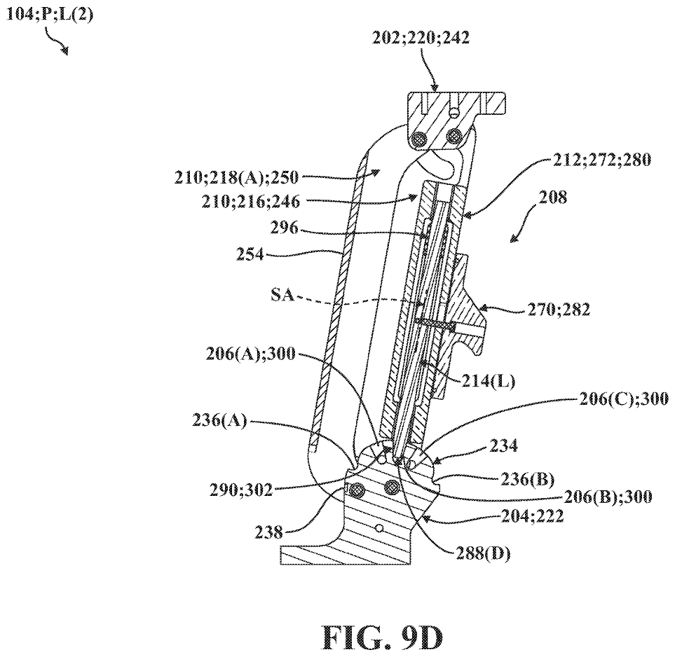

Referring now to FIGS. 3A-9D, as noted above, the arm assembly 104 is operatively attached to the intermediate frame 124 of the patient transport apparatus 102 and releasably secures the medical device 106 for concurrent movement with the patient transport apparatus 102. To this end, the arm assembly 104 generally includes a coupler 202 which supports the interface 184, a knuckle 204 operatively attached to the intermediate frame 124 of the patient transport apparatus 102 and defining at least one receiver 206, and a carrier 208 supporting the coupler 202 for movement relative to the knuckle 204 between a plurality of arm positions P (compare FIGS. 3A-3F) including at least one locked arm position L (see FIGS. 3C-3E). The carrier 208 generally includes a linkage 210 and a selector 212. The linkage 210 is pivotably coupled to the knuckle 204 and to the coupler 202 to maintain a predetermined alignment PA of the coupler 202 relative to the intermediate frame 124 between the plurality of arm positions P (compare FIGS. 3A-3F). The selector 212 is operatively attached to the linkage 210 and supports a shuttle 214 for user selective movement between a locked shuttle position 214L (see FIGS. 9A and 9D; see also FIGS. 7C-7E) and a disengaged shuttle position 214D (see FIGS. 9B-9C). During operation in the locked shuttle position 214L (see FIGS. 9A and 9D), the shuttle 214 is disposed in engagement with the at least one receiver 206 to inhibit movement of the coupler 202 relative to the knuckle 204 between the plurality of arm positions P from the at least one locked arm position L. During operation in the disengaged shuttle position 214D (see FIGS. 9B-9C), the shuttle 214 is spaced from the at least one receiver 206 to permit movement of the coupler 202 relative to the knuckle 204 between the plurality of arm positions P from the at least one locked arm position L.

The arm assembly 104 allows users such as the caregiver to selectively move the medical device 106 relative to the patient transport apparatus 102 between different arm positions P, while maintaining the predetermined alignment PA of the medical device 106 relative to the intermediate frame 124 in each of the arm positions P, with one or more of the arm positions P serving as locked arm positions L in which the coupler 202 supporting the interface 184 (and, thus, the secured medical device 106) is prevented from moving relative to the knuckle 204 until the user moves the shuttle 214 out of the locked shuttle position 214L. It will be appreciated that operation of the shuttle 214 in the locked shuttle position 214L keeps the medical device 106 secured relative to the patient transport apparatus 102 in a safe, efficient way and under a number of different operating conditions while, at the same time, affording predictable and consistent orientation of the medical device 106 relative to the patient transport apparatus 102. Each of the components of the arm assembly 104 introduced above will be described in greater detail below.

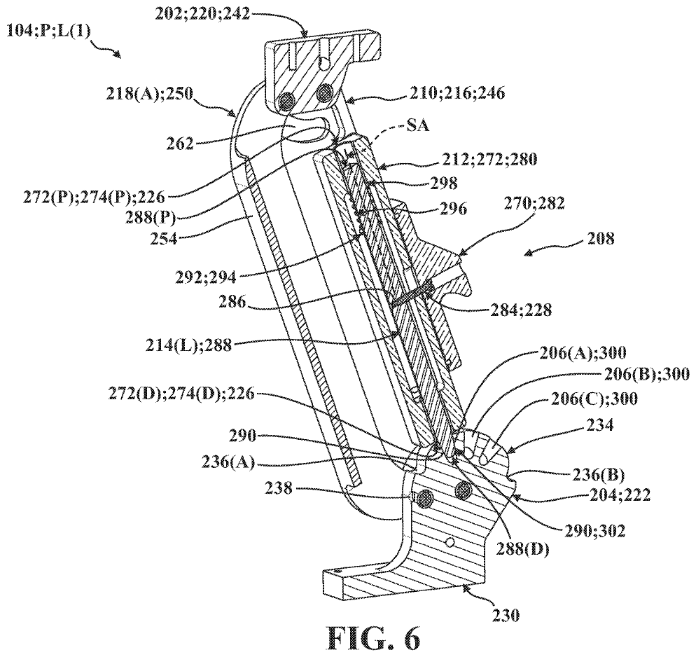

Referring now to FIGS. 4A-4B and 6, as noted above, the carrier 208 of the arm assembly 104 employs the linkage 210 pivotably coupled between the coupler 202 and the knuckle 204 to maintain the predetermined alignment PA of the coupler 202 relative to the intermediate frame 124 between the plurality of arm positions P. It will be appreciated that maintaining the predetermined alignment PA between the different arm positions P affords opportunities for a more rigid and secure connection between the interface 184 and the mount 186. More specifically, because the arm assembly 104 is configured so that changing between arm positions P does not “tilt” or “pan” the medical device 106 (e.g., about axes extending laterally or longitudinally relative to the intermediate frame 124), additional linkages and pivoting connections (which might otherwise reduce how rigidly the medical device 106 is secured) to correct for “tilt” or “pan” can be avoided.

In the representative version illustrated herein, the linkage 210 includes a brace 216 and a timing link 218. The brace 216 is pivotably coupled to the knuckle 204 along a first knuckle axis KA1 and is pivotably coupled to the coupler 202 along a first coupler axis CA1, and the timing link 218 is pivotably coupled to the knuckle 204 along a second knuckle axis KA2 and is pivotably coupled to the coupler 202 along a second coupler axis CA2 (see FIG. 4A). To this end, and as is best depicted in FIG. 4B, the coupler 202 includes a coupler body 220 and the knuckle 204 includes a knuckle body 222, and bores 224 are defined in the coupler body 220 and in the knuckle body 222 along the axes KA1, KA2, CA1, CA2 (see FIGS. 4A-4B). The bores 224 support respective bushings 226 and fasteners 228 (e.g., bolts and nuts) to secure the components of the linkage 210 together and facilitate pivoting movement. It will be appreciated that various arrangements of components of various styles and/or types could be employed to facilitate pivoting movement, including without limitation pins, washers, bushings, bearings, seals, shafts, clips, keepers, springs, and the like.

As is best shown in FIG. 4B, the knuckle 204 includes a knuckle mount 230 operatively attached to the knuckle body 222. The knuckle mount 230 is configured for attachment to the intermediate frame 124 or another portion of the patient transport apparatus 102. To this end, in the illustrated version of the knuckle mount 230 includes knuckle apertures 232 shaped and arranged to receive fasteners 228 to facilitate attachment to the intermediate frame 124 (see FIGS. 3A-3F; not shown in detail). However, it will be appreciated that the knuckle 204 could be operatively attached to the intermediate frame 124 or another portion of the patient transport apparatus 102 in other ways without departing from the scope of the present disclosure, including without the use of fasteners 228. By way of non-limiting example, the knuckle 204 could be formed integrally with a portion of the patient transport apparatus 102 or could be welded to the intermediate frame 124. Other configurations are contemplated. The knuckle body 222 of the knuckle 204 also includes or otherwise defines a knuckle interface surface 234 along which the at least one receiver 206 is arranged, as well as at least one notch 236 and at least one seat 238, each of which are described in greater detail below.

The coupler body 220 of the coupler 202 includes or otherwise defines a coupler mount 240 configured to support the interface 184. In the illustrated version, the coupler mount 240 defines a reference surface 242 and coupler apertures 244 shaped and arranged to receive fasteners 228 to facilitate attachment to the interface 184 (see FIG. 4A; not shown in detail). However, it will be appreciated that the coupler 202 could be operatively attached to the interface 184 in other ways without departing from the scope of the present disclosure, including without the use of fasteners 228. By way of non-limiting example, the coupler 202 could be formed integrally with the interface 184 or could otherwise define the interface 184. Other configurations are contemplated.

The first and second knuckle axes KA1, KA2 and the first and second coupler axes CA1, CA2 are all arranged in spaced relation to each other and are all substantially parallel with each other in the illustrated version. With this configuration, the linkage 210 may be further defined as a four-bar linkage 210 pivotably coupled to the knuckle 204 and to the coupler 202 to maintain the predetermined alignment PA of the coupler 202 (and, thus, the medical device 106) relative to the intermediate frame 124 of the patient transport apparatus 102 between the plurality of arm positions P. More specifically, with this configuration, the arm assembly 104 maintains a substantially parallel predetermined alignment PA of the reference surface 242 of the coupler 202 relative to the longitudinal direction defined between the head end HE and the foot end FE of the intermediate frame 124 (not shown in detail). However, other configurations are contemplated, and it will be appreciated that the reference surface 242 could be defined in various ways relative to the medical device 106, the intermediate frame 124, and/or other parts of the patient transport apparatus 102 or the arm assembly 104, such as to orientate the coupler 202 relative to the intermediate frame 124 in a non-parallel fashion to define the predetermined alignment PA. Similarly, while the linkage 210 is realized as a four-bar linkage 210 in the illustrated version, it will be appreciated that maintaining the predetermined alignment PA can be achieved with carriers 208 of different types, such as those employing other types of links, pivoting connections, and the like. Other configurations are contemplated.

As will be appreciated from the subsequent description of the selector 212 and the linkage 210 below, the carrier 208 is configured so as to conceal, shield, or otherwise block access to various components of the arm assembly 104 in order to, among other things, limit contact of external objects with the shuttle 214, pivoting connections PC along the axes KA1, KA2, CA1, CA2 (see FIG. 4A), and/or in or adjacent to gaps between component. This helps minimize the risk of potential “pinch points” and also helps facilitate consistent operation of the arm assembly 104 by minimizing opportunities for ingress of contaminants. To this end, the brace 216 and the timing link 218 are each shaped to limit contact of external objects with pivoting connections PC adjacent to one or more of the knuckle 204 and the coupler 202.

As is best shown in FIG. 4B, the brace 216 of the linkage 210 is realized as a first brace link 246 and a second brace link 248. However, it will be appreciated that other configurations are contemplated, and the brace 216 could be realized with a single component or with more than two components (e.g., three or more brace links). The timing link 218 is realized with a profile that has a generally U-shaped cross section (not shown in detail), and includes or otherwise defines a first timing link wall 250 defining a first timing link side 218A, a second timing link wall 252 defining a second timing link side 218B, and a lower link wall 254 extending laterally between the first and second timing link walls 250, 252. Here, the first and second timing link walls 250, 252 extend from the lower link wall 254 to respective first and second timing link edges 256, 258. The first brace link 246 is disposed adjacent to the first timing link side 218A, and the second brace link 248 is disposed adjacent to the second timing link side 218B, with the timing link 218 extending laterally between the first and second timing link sides 218A, 218B. Here, the first and second brace links 246, 248 are shaped to limit contact of external objects with one or more of the first and second timing link edges 256 258.

In the illustrated version, as shown in FIG. 4B, the first and second brace links 246, 248 each include respective brace pivot bores 260 which receive the fasteners 228 of the pivoting connections PC along the first coupler axis CA1 and the first knuckle axis KA1, and also include curved slots 262 which are shaped and arranged to accommodate ends of the fasteners 228 provided at the pivoting connections PC along the second coupler axis CA2 and the second knuckle axis KA2. The first and second brace links 246, 248 also each include lateral projections 264 shaped to be received within receive pockets 266 of the selector 212, and brace fastener apertures 268 to receive fasteners 228 utilized to secure the first and second brace links 246, 248 to the selector 212. In addition, the first and second brace links 248 also each define a relief 269 arranged to accommodate portions of a user interface 270 which, as is described in greater detail below, is operatively attached to the shuttle 214 to move the shuttle 214 towards the disengaged shuttle position 214D.

As noted above, the selector 212 is operatively attached to the linkage 210 and supports the shuttle 214 for movement into and out of engagement with the at least one receiver 206. In the illustrated version, the selector 212 includes a selector body 272 extending between a distal selector end 272D and a proximal selector end 272P, and defines a selector bore 274 arranged along a selector axis SA adjacent to the distal selector end 272D, with the shuttle 214 supported for selective movement along the selector axis SA between the locked shuttle position 214L and the disengaged shuttle position 214D. The selector body 272 includes selector fastener apertures 276 arranged to receive fasteners 228 that also extend through the brace fastener apertures 268 to operatively attach the selector body 272 to the first and second brace links 246, 248 for concurrent movement between the plurality of arm positions P. A window 278 defined by the pockets 266 is formed extending laterally through the selector body 272 spaced from the distal and proximal selector ends 272D, 272P, and is shaped to receive the lateral projections 264 of the first and second brace links 246, 248. In the illustrated version, the selector bore 274 extends along the selector axis SA from the proximal selector end 272P to the distal selector end 272D, with the window 278 formed therebetween so as to delineate the selector bore 274 into proximal and distal bore regions 274P, 274D each supporting a bushing 226 arranged to slidably support the shuttle 214 (see FIG. 4B).

The selector body 272 also defines an upper selector wall 280 arranged laterally between the first and second brace links 246, 248. Here, the upper selector wall 280 and the lower link wall 254 are each shaped to limit contact of external objects with the shuttle 214 in that the shuttle 214 is generally concealed within the selector body 272 by the linkage 210. The upper selector wall 280 also defines a selector slot 281 extending into communication with the window 278 between the distal and proximal selector ends 272D, 272P. Here, the user interface 270 includes a grip 282 arranged for user engagement, and a grip aperture 284 arranged to receive a fastener 228 which extends through the selector slot 281 and into engagement with a shuttle aperture 286 of the shuttle 214 to secure the user interface 270 for concurrent movement with the shuttle 214. As will be appreciated from the subsequent description below, the user interface 270 is arranged for user engagement to move the shuttle 214 away from the locked shuttle position 214L in response to force selectively applied by the user (e.g., to the grip 282).

As is best shown in FIGS. 4B and 6, the shuttle 214 includes a shuttle body 288 extending between a proximal shuttle end 288P and a distal shuttle end 288D, with a tip 290 disposed adjacent to the distal shuttle end 288D. The shuttle aperture 286 and a groove 292 spaced from the shuttle aperture 286 are each formed in the shuttle body 288 between the proximal shuttle end 288P and the distal shuttle end 288D. The groove 292 is shaped and arranged to support a clip 294 which, in turn, supports a biasing element 296 arranged to urge the shuttle 214 towards the locked shuttle position 214L. Here, the biasing element 296 is disposed in the window 278 and may be braced against a spring seat 298 (e.g., a washer) in contact with the selector body 272 adjacent to the proximal selector end 272P. As will be appreciated from the subsequent description of the one or more receivers 206, the one or more notches 236, and the one or more seats 238 below, biasing force from the biasing element 296 helps maintain operation in certain predetermined arm positions P by urging the shuttle 214 towards the locked shuttle position 214L, and also helps facilitate transitioning between the plurality of different arm positions P such as by facilitating sliding engagement of the distal shuttle end 288D with the knuckle interface surface 234 of the knuckle 204 in scenarios where the biasing force exceeds force applied by the user to the user interface 270 during movement between different arm positions P.

With reference to FIGS. 3A-9D, as noted above, the arm assembly 104 is selectively movable between the plurality of arm positions P (compare FIGS. 3A-3F) which includes at least one locked arm position L (see FIGS. 3C-3E) where engagement between the shuttle 214 of the selector 212 and the at least one receiver 206 of the knuckle 204 inhibits movement out of the selected at least one locked arm position L during operation of the shuttle 214 in the locked shuttle position 214L. To this end, the at least one receiver 206 defines a receiver profile 300, and the tip 290 of the shuttle 214 adjacent to the distal shuttle end 288D defines an end profile 302 shaped complimentarily to the receiver profile 300 to limit movement of the shuttle 214 relative to the knuckle 204 from the locked shuttle position 214L in a plurality of degrees of freedom. In the illustrated version, the end profile 302 of the shuttle 214 and the receiver profile 300 of the at least one receiver 206 each have generally frustoconical configurations which limit movement of the shuttle 214 in four degrees of freedom by inhibiting rotation in two degrees of freedom and translation in two rotational degrees of freedom. It will be appreciated that this configuration of the receiver profile 300 and the end profile 302 helps facilitate secure, rigid, consistent operation in the locked arm position L.

In the illustrated version, the at least one receiver 206 of the knuckle 204 is further defined as a plurality of receivers 206A, 206B, 206C each arranged to engage the shuttle 214 in the locked shuttle position 214L to define a respective locked arm position L1, L2, L3 (see FIGS. 3C-3E; see also FIGS. 7C-7E). More specifically, in the representative version illustrated herein, the plurality of arm positions P include different first, second, and third locked arm positions L1, L2, L3 which are each respectively defined by different first, second, and third receivers 206A, 206B, 206C of the knuckle 204.

The first, second, and third locked arm positions L1, L2, L3 are each configured so as to position the medical device 106 in different predetermined ways relative to the intermediate frame 124 of the patient transport apparatus 102. In the illustrated version, the coupler 202 (and, thus, the medical device 106) is arranged closer to the head end HE of the patient transport apparatus 102 in the first locked arm position L1 than in the second locked arm position L2 (compare FIGS. 3C-3D). Further, the coupler 202 is arranged vertically closer to the intermediate frame 124 in the first locked arm position L1 than in the second locked arm position L2 (compare FIGS. 3C-3D). Here too in this version, the coupler 202 is arranged closer to the head end HE in the second locked arm position L2 than in the third locked arm position L3 (compare FIGS. 3D-3E). Moreover, the coupler 202 is arranged vertically closer to the intermediate frame 124 in the third locked arm position L3 than in the second locked arm position L2 (compare FIGS. 3D-3E). It will be appreciated that the forgoing describes exemplary arrangements of the medical device 106 in the first, second, and third locked arm positions L1, L2, L3, and that other configurations are contemplated.

The plurality of receivers 206A, 206B, 206C are formed in the knuckle interface surface 234 of the knuckle 204. However, various configurations of receivers 206 are contemplated by the present disclosure, and the knuckle 204 and/or other portions of the arm assembly 104 may define or otherwise include different quantities of receivers 206 (e.g., more than three or less than three), with receiver profiles 300 that are similar or different to one another, and that may be arranged in various ways sufficient to engage the shuttle 214 in respective locked shuttle positions 214L to inhibit movement between the plurality of arm positions P.

In some versions, the plurality of arm positions P may also include at least one catch arm position C different from the at least one locked arm position L (see FIGS. 7B and 7F; compare with FIGS. 7C-7E). Here, the knuckle 204 defines the at least one notch 236 spaced from the at least one receiver 206, such as disposed in spaced relation along the knuckle interface surface 234, and the shuttle 214 is further arranged for movement from the disengaged shuttle position 214D to a catch shuttle position 214C disposed in engagement with the at least one notch 236 to limit movement of the coupler 202 relative to the knuckle 204 in one direction but not in an opposite direction (see FIGS. 7B and 7F). More specifically, operation of the shuttle 214 in the catch shuttle position 214C disposed in engagement with the at least one notch 236 simultaneously: inhibits movement of the coupler 202 relative to the knuckle 204 from the at least one catch arm position C in a block direction DB away from the at least one locked arm position L; and permits movement of the coupler 202 relative to the knuckle 204 from the at least one catch arm position C in a permit direction DP, opposite to the block direction DB, towards the at least one locked arm position L.

In the illustrated version, the at least one notch 236 of the knuckle 204 is further defined as a plurality of notches 236A, 236B each arranged to engage the shuttle 214 in the catch shuttle position 214C to define a respective catch arm position C1, C2 (see FIGS. 3B and 3F; see also FIGS. 7B and 7F). More specifically, in the representative version illustrated herein, the plurality of arm positions P include different first and second catch arm positions C1, C2 which are each respectively defined by different first and second notches 236A, 236B of the knuckle 204. The, the first and second notches 236A, 236B are arranged on different sides of the knuckle 204 along the knuckle interface surface 234, with the at least one receiver 206 being arranged between the first and second notches 236A, 236B.

The first and second catch arm positions C1, C2 are each configured so as to position the medical device 106 in different predetermined ways relative to the intermediate frame 124 of the patient transport apparatus 102. In the illustrated version, the coupler 202 (and, thus, the medical device 106) is arranged vertically closer to the intermediate frame 124 of the patient transport apparatus 102 in each of the first and second catch arm positions C1, C2 than in any of the first, second, and third locked arm positions L1, L2, L3 (compare FIGS. 3B and 3F to FIGS. 3C-3E). In addition, the coupler 202 is arranged closer to the head end HE in the first catch arm position C1 than in second catch arm position C2 or any of the first, second, and third locked arm positions L1, L2, L3 (compare FIG. 3B with FIGS. 3C-3F). It will be appreciated that the forgoing describes exemplary arrangements of the medical device 106 in the first and second catch arm positions C1, C2, and that other configurations are contemplated.

As depicted in FIG. 7B, in the illustrated version, engagement of the shuttle 214 with the first notch 236A in the catch shuttle position 214C inhibits movement in the block direction DB away from the at least one receiver 206 and simultaneously permits movement in the permit direction DP towards the at least one receiver 206. Here too in this version, as is depicted in FIG. 7F, engagement of the shuttle 214 with the second notch 236B in the catch shuttle position 214C inhibits movement in the block direction DB away from the at least one receiver 206 and simultaneously permits movement in the permit direction DP towards the at least one receiver 206. It will be appreciated that the block directions DB defined by the respective first and second notches 236A, 236B are opposite to each other (compare FIGS. 7B and 7F). While the illustrated version employs a plurality of notches 236, various configurations of notches 236 are contemplated by the present disclosure, and the knuckle 204 and/or other portions of the arm assembly 104 may define or otherwise include different quantities of notches 236 (e.g., more than two or less than two) arranged in various ways sufficient to engage the shuttle 214 in respective catch shuttle positions 214C to inhibit movement in one direction, but not an opposite direction, between the plurality of arm positions P.

It will be appreciated that utilizing one or more notches 236 may advantageously allow caregivers to quickly and efficiently move the arm assembly 104 into the at least one locked arm position L via the application of force to the medical device 106 or portions of the arm assembly 104 which effect movement in the permit direction DP without also requiring that the user engage the user interface 270 operatively attached to the shuttle 214 to move the shuttle 214 towards the disengaged shuttle position 214D. Put differently, while movement out of the at least one locked arm position L necessitates that the user apply force in a specific direction (e.g., applied to the grip 282 of the user interface 270 in a direction acting along the selector axis SA) to move the shuttle 214 out of the locked shuttle position 214L, movement out of the at least one catch arm position C can be achieved without requiring that the user apply force to the user interface 270 to move the shuttle 214 based, among other things, on the shape and arrangement of the at least one notch 236. Here, for example, biasing force from the biasing element 296 urges the distal shuttle end 288D of the shuttle 214 into sliding engagement with the knuckle interface surface 234 during movement between arm positions P and in situations where the user is not applying force to the user interface 270 or is applying force which is insufficient to overcome the biasing force exerted by the biasing element 296. Because the at least one notch 236 merges smoothly into or is otherwise defined as a part of the knuckle interface surface 234, the sliding engagement of the distal shuttle end 288D of the shuttle 214 along the knuckle interface surface 234 ensures predictable, smooth operation into the at least one catch arm position C.

It will be appreciated that the at least one catch arm position C also affords improved safety and usability by stopping movement of the arm assembly 104 outside of the at least one locked arm position L, which may be advantageously implemented in versions where additional arm positions P are utilized beyond the at least one catch arm position C (and also beyond the at least one locked arm position L). By way of non-limiting example, in some versions, the plurality of arm positions P may include at least one stowed arm position S different from the at least one locked arm position L and different from the at least one catch arm position C (see FIG. 7A; compare with FIGS. 7B-7F). Here, the knuckle 204 defines the at least one seat 238 spaced from the at least one receiver 206, such as disposed in spaced relation from the knuckle interface surface 234 on another portion of the knuckle 204, and the shuttle 214 is further arranged for movement from the disengaged shuttle position 214D to a stowed shuttle position 214S disposed in engagement with the at least one seat 238 to at least partially limit movement of the coupler 202 relative to the knuckle 204 from the at least one stowed arm position S.

Here, the stowed arm position S may be employed to facilitate storing the arm assembly 104 out of the way when the medical device 106 is not being utilized or when the medical device 106 is not secured to the interface 184 of the arm assembly 104. In this version, a single seat 238 is employed, and the first notch 236A is arranged relative to the at least one receiver 206 and the seat 238 so as to position the first catch arm position C1 between the at least one stowed arm position S and the at least one locked arm position L. The at least one seat 238 may be shaped and arranged to receive the distal shuttle end 288D of the shuttle 214 to help prevent vibration, noise, and the like during operation in the stowed arm position S. In some versions, the shapes of the distal shuttle end 288D and the at least one seat 238 may be configured to resist movement out of the stowed arm position S up to a predetermined amount of applied force acting on the arm assembly 104 and/or the medical device 106, such as to permit movement of the shuttle 214 along the selector axis SA as the user pulls up on the arm assembly 104, without necessarily requiring that the user engage the user interface 270. Other configurations are contemplated, and it will be appreciated that the at least one seat 238 could instead be configured similar to the at least one notch 236 or the at least one receiver 206.

The stowed arm position S, like the locked arm positions L and the catch arm positions C, is configured so as to position the medical device 106 in a predetermined way relative to the intermediate frame 124 of the patient transport apparatus 102. In the illustrated version, the coupler 202 (and, thus, the medical device 106) is arranged closer to the head end HE of the patient transport apparatus 102 in the stowed arm position S than in either of the first and second catch arm positions C1, C2 (see FIG. 3A; compare with FIGS. 3B and 3F). In addition, the coupler 202 is arranged vertically closer to the intermediate frame 124 in the stowed arm position S than in either of the first and second catch arm positions C1, C2 (see FIG. 3A; compare with FIGS. 3B and 3F). Further, the coupler 202 is arranged closer to the head end HE of the patient transport apparatus 102 in the first catch arm position C1 than in the second catch arm position C2 (compare FIG. 3B with FIG. 3F). It will be appreciated that the forgoing describes exemplary arrangements of the medical device 106 in the stowed arm position S, and that other configurations are contemplated.

Because the arm assembly 104 is configured for movement to the stowed arm position S, which is arranged beyond the first catch arm position C1 in the illustrated version, safety is improved for situations which might otherwise cause the arm assembly 104 to move from the one or more locked arm positions L directly into the stowed arm position S. By way of illustrative example, if the user were to slip or inadvertently release the arm assembly 104 from the at least one locked arm position L, movement between the plurality of arm positions P occurring because of the weight of the medical device 106 would cease at the first catch arm position C1 rather than continuing to the stowed arm position S. In this version, engagement of the shuttle 214 with the first notch 236A in the catch shuttle position 214C further defines the first catch arm position Cl as a safety catch arm position C1 to interrupt movement of the arm assembly 104 towards the stowed arm position S (see FIG. 3B; compare to FIG. 3A). It will be appreciated that the user could subsequently apply force to the user interface 270 sufficient to overcome the biasing force of the biasing element 296 in order to move the shuttle 214 along the selector axis SA toward the disengaged shuttle position 214D to move beyond the safety catch arm position C1 and into the stowed arm position S.

In some versions, engagement of the shuttle 214 with the second notch 236A in the catch shuttle position 214C further defines the second catch arm position C2 as a transfer catch arm position C2 to position the medical device 106 and the arm assembly 104 relative to the intermediate frame 124 with the linkage 210 arranged extending away from the head end HE so as to facilitate patient transfer relative to the patient support deck 126 in the transfer catch arm position C2 (see FIG. 3F; not shown in detail).

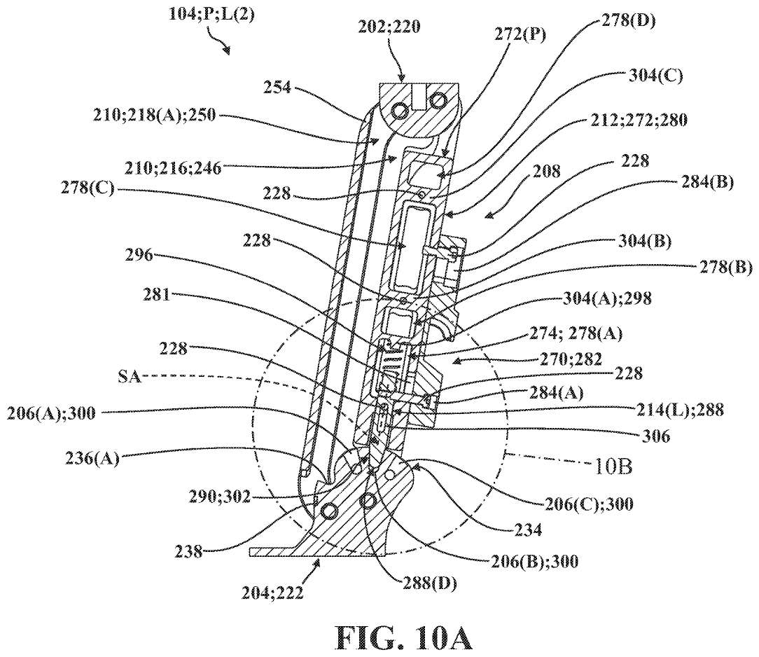

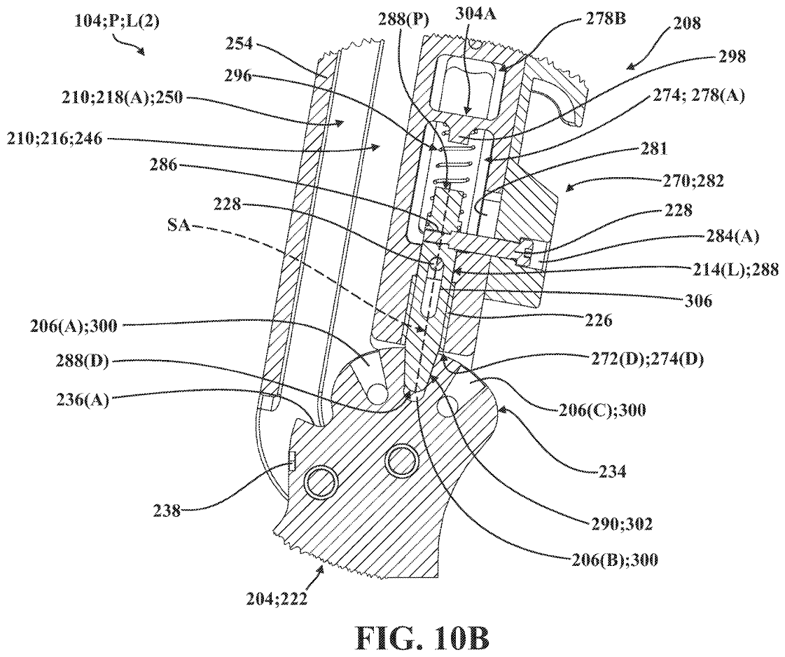

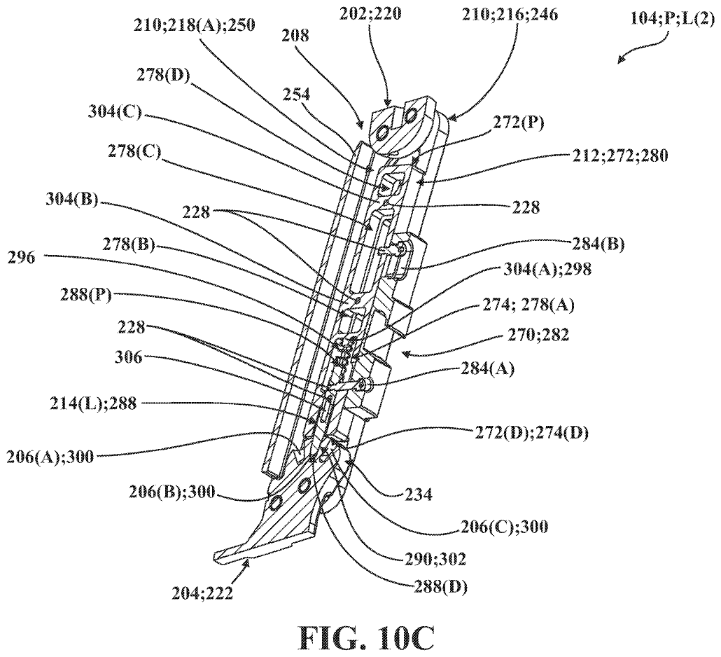

FIGS. 10A through 10C illustrate another configuration of the arm assembly 104 according to the present disclosure. The configuration of the arm assembly 104 illustrated in FIGS. 10A through 10C is generally similar to the other configurations of the arm assembly 104 provided for above in the present disclosure, apart from the specific differences outlined below. In other words, duplicative description of the structural commonalities between the arm assembly 104 illustrated in FIGS. 10A through 10C and other configurations of the arm assembly 104 provided for herein have been omitted for brevity.

In the configuration of FIGS. 10A through 10C, the selector body 272 defines a plurality of windows 278. In the illustrated example, the plurality of windows 278 includes a first window 278A arranged closest to the distal selector end 272D, as well as a second window 278B, a third window 278C, and fourth window 278D arranged progressively closer to the proximal selector end 272P. It should be appreciated that in other configurations, the plurality of windows 278 may include more or less windows 278. The selector body 272 may define a plurality of window walls 304 which subdivide the selector body 272 to define the plurality of windows 278A, 278B, 278C, 278D. For example, in the configuration of FIGS. 10A through 10C, the plurality of window walls 304 includes a first window wall 304A dividing the first window 278A and the second window 278B, a second window wall 304B dividing the second window 278B and the third window 278C, a third window wall 304C dividing the third window 278C and the fourth window 278D. As best shown in FIG. 10B, in these examples, the biasing element 296 is disposed in the first window 278A and may be braced against a spring seat 298 defined by the first window wall 304A such that the shuttle is arranged for movement within the first window 278A and the biasing element 296 urges the shuttle 214 towards the locked shuttle position 214L.

With continued reference to FIG. 10B, in this configuration, the upper selector wall 280 defines the selector slot 281 extending into communication with the first window 278A. Here, the user interface 270 includes a first grip aperture 284A arranged to receive a fastener 228 which extends through the selector slot 281 and into engagement with the shuttle aperture 286 to secure the user interface 270 for concurrent movement with the shuttle 214. Accordingly, the user interface 270 is arranged for user engagement to move the shuttle 214 away from the locked shuttle position 214L in response to force selectively applied by the user (e.g., to the grip 282). As best shown in FIGS. 10A and 10C, in this version the user interface 270 also includes a second grip aperture 284B arranged to receive a fastener 228 which extends into another portion of the selector body 272 (e.g., the third window 278C). Here, the fastener 228 is fixed relative to the selector body 272, and the second grip aperture 284B is realized as a slot such that the fastener 228 rides within the second grip aperture 284B as the shuttle 214 moves away from the locked shuttle position 214L in response to force selectively applied by the user (e.g., to the grip 282).

As described above, the selector body 272 includes selector fastener apertures 276 arranged to receive fasteners 228 that also extend through the brace fastener apertures 268 to operatively attach the selector body 272 to the first and second brace links 246, 248 for concurrent movement between the plurality of arm positions P. In the configuration of FIGS. 10A through 10C, one of these fasteners 228 may extend through the shuttle 214 (e.g., through the shuttle body 288). In these examples, as best shown in FIG. 10B, the shuttle 214 may define a shuttle slot 306 for engaging the fastener 228 such that the fastener 228 rides within the shuttle slot 306 as the shuttle 214 moves away from the locked shuttle position 214L in response to force selectively applied by the user (e.g., to the grip 282).

As best shown in FIG. 10B, here too in this version, the knuckle 204 is likewise configured with a plurality of receivers 206A, 206B, 206C each arranged to engage the shuttle 214 in the locked shuttle position 214L to define a respective locked arm position L1, L2, L3 (not shown in detail in this version), and also likewise includes the seat 238 to at least partially limit movement of the coupler 202 relative to the knuckle 204 from the at least one stowed arm position S (not shown in detail in this version). However, in this version, rather than employing first and second notches 236A, 236B each arranged to engage the shuttle 214 in the catch shuttle position 214C to define respective catch arm positions C1, C2 (see FIGS. 3B and 3F; see also FIGS. 7B and 7F), the version depicted in FIGS. 10A-10C employs the first notch 236A to engage the shuttle 214 in the catch arm position C1 but omits second notch 236B (compare version depicted in FIG. 7D with version depicted in FIG. 10B). As noted previously, other configurations are contemplated.

It will be further appreciated that the terms “include,” “includes,” and “including” have the same meaning as the terms “comprise,” “comprises,” and “comprising.” Moreover, it will be appreciated that terms such as “first,” “second,” “third,” and the like are used herein to differentiate certain structural features and components for the non-limiting, illustrative purposes of clarity and consistency.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A patient support system for concurrently transporting a patient and a medical device, the patient support system comprising:
a patient transport apparatus including a base arranged for movement along floor surfaces, and an intermediate frame coupled to the base and defining a patient support deck; and
an arm assembly including:
   a coupler supporting an interface for releasably securing the medical device,
   a knuckle operatively attached to the intermediate frame of the patient transport apparatus and defining at least one receiver, and
   a carrier supporting the coupler for movement relative to the knuckle between a plurality of arm positions including at least one locked arm position, the carrier including:
      a linkage pivotably coupled to the knuckle and to the coupler to maintain a predetermined alignment of the coupler relative to the intermediate frame between the plurality of arm positions, and
      a selector operatively attached to the linkage and supporting a shuttle for selective movement between:
         a locked shuttle position disposed in engagement with the at least one receiver to inhibit movement of the coupler relative to the knuckle between the plurality of arm positions from the at least one locked arm position; and
         a disengaged shuttle position spaced from the at least one receiver to permit movement of the coupler relative to the knuckle between the plurality of arm positions from the at least one locked arm position.
II. The patient support system as set forth in clause I, wherein the linkage of the carrier includes a brace pivotably coupled to the knuckle and pivotably coupled to the coupler, and a timing link pivotably coupled to the knuckle and pivotably coupled to the coupler.
III. The patient support system as set forth in clause II, wherein the timing link extends laterally between a first timing link side and a second timing link side; and
   wherein the brace includes a first brace link disposed adjacent to the first timing link side, and a second brace link disposed adjacent to the second timing link side.
IV. The patient support system as set forth in clause III, wherein the selector includes a selector body operatively attached to each of the first brace link and the second brace link for concurrent movement between the plurality of arm positions.
V. The patient support system as set forth in clause IV, wherein the selector body defines an upper selector wall arranged laterally between the first brace link and the second brace link;
   wherein the timing link defines a lower link wall extending laterally between the first timing link side and the second timing link side; and
   wherein the upper selector wall and the lower link wall are each shaped to limit contact of external objects with the shuttle.
VI. The patient support system as set forth in clause V, wherein the timing link includes a first timing link wall defining the first timing link side and extending from the lower link wall to a first timing link edge, and a second timing link wall defining the second timing link side and extending from the lower link wall to a second timing link edge; and
wherein the first brace link and the second brace link are shaped to limit contact of external objects with one or more of the first timing link edge and the second timing link edge.
VII. The patient support system as set forth in any one of clauses II to VI, wherein the brace and the timing link are shaped to limit contact of external objects with pivoting connections adjacent to one or more of the knuckle and the coupler.
VIII. The patient support system as set forth in any one of clauses I to VII, wherein the linkage is further defined as a four-bar linkage pivotably coupled to the knuckle and to the coupler to maintain the predetermined alignment of the coupler relative to the intermediate frame between the plurality of arm positions.
IX. The patient support system as set forth in clause VIII, wherein the predetermined alignment is further defined as substantially parallel alignment.
X. The patient support system as set forth in any one of clauses I to IX, wherein the at least one receiver defines a receiver profile; and
wherein the shuttle includes a shuttle body extending between a distal shuttle end and a proximal shuttle end with a tip disposed adjacent to the distal shuttle end, the tip defining an end profile shaped complimentarily to the receiver profile of the at least one receiver to limit movement of the shuttle relative to the knuckle from the locked shuttle position in a plurality of degrees of freedom.
XI. The patient support system as set forth in clause X, wherein the end profile of the shuttle has a generally frustoconical configuration; and
wherein the plurality of degrees of freedom is further defined as four degrees of freedom.
XII. The patient support system as set forth in any one of clauses I to XI, wherein the at least one receiver of the knuckle is further defined as a plurality of receivers each arranged to engage the shuttle in the locked shuttle position to define a respective locked arm position.
XIII. The patient support system as set forth in clause XII, wherein the plurality of receivers includes a first receiver and a second receiver;
wherein engagement of the shuttle with the first receiver in the locked shuttle position defines a first locked arm position; and
wherein engagement of the shuttle with the second receiver in the locked shuttle position defines a second locked arm position different from the first locked arm position.
XIV. The patient support system as set forth in clause XIII, wherein the patient transport apparatus defines a head end and a foot end spaced longitudinally from the head end; and
wherein the coupler is arranged closer to the head end of the patient transport apparatus in the first locked arm position than in the second locked arm position.
XV. The patient support system as set forth in clause XIV, wherein the coupler is arranged vertically closer to the intermediate frame in the first locked arm position than in the second locked arm position.
XVI. The patient support system as set forth in any one of clauses XIV or XV, wherein the plurality of receivers further includes a third receiver; and
wherein engagement of the shuttle with the third receiver in the locked shuttle position defines a third locked arm position different from the first locked arm position and the second locked arm position.
XVII. The patient support system as set forth in clause XVI, wherein the coupler is arranged closer to the head end of the patient transport apparatus in the second locked arm position than in the third locked arm position.
XVIII. The patient support system as set forth in clause XVII, wherein the coupler is arranged vertically closer to the intermediate frame in the third locked arm position than in the second locked arm position.
XIX. The patient support system as set forth in any one of clauses XII to XVIII, wherein the knuckle defines a knuckle interface surface, the plurality of receivers being formed in the knuckle interface surface.
XX. The patient support system as set forth in any one of clauses I to XIX, wherein the selector includes a selector body defining a selector bore arranged along a selector axis, with the shuttle supported for selective movement along the selector axis between the locked shuttle position and the disengaged shuttle position.
XXI. The patient support system as set forth in clause XX, wherein the shuttle includes a shuttle body extending between a distal shuttle end and a proximal shuttle end with a tip disposed adjacent to the distal shuttle end arranged for selective engagement with the at least one receiver in the locked shuttle position;
wherein the selector body extends between a distal selector end and a proximal selector end, the selector bore being arranged adjacent to the distal selector end; and
wherein selective movement of the selector from the locked shuttle position toward the disengaged shuttle position moves the tip of the shuttle towards the proximal selector end.
XXII. The patient support system as set forth in clause XXI, wherein the carrier further includes a biasing element interposed between the shuttle and the selector to urge the shuttle towards the locked shuttle position, and a user interface operatively attached to the shuttle body and arranged for user engagement to move the shuttle away from the locked shuttle position in response to force applied by the user to the user interface.
XXIII. The patient support system as set forth in clause XXII, wherein the knuckle defines a knuckle interface surface, the at least one receiver being formed in the knuckle interface surface; and
wherein the distal shuttle end of the shuttle is disposed in sliding engagement with the knuckle interface surface of the knuckle during movement between the plurality of arm positions in response to biasing force from the biasing element exceeding force applied by the user to the user interface.
XXIV. The patient support system as set forth in clause XXIII, wherein the user interface includes a grip arranged for user engagement, with the grip arranged for concurrent movement with the shuttle.
XXV. The patient support system as set forth in clause XXIII, wherein the knuckle defines at least one notch spaced from the at least one receiver along the knuckle interface surface;
wherein the plurality of arm positions includes at least one catch arm position; and
wherein the shuttle is further arranged for movement from the disengaged shuttle position to a catch shuttle position disposed in engagement with the at least one notch to limit movement of the coupler relative to the knuckle by simultaneously:
   inhibiting movement of the coupler relative to the knuckle from the at least one catch arm position in a block direction away from the at least one locked arm position, and
   permitting movement of the coupler relative to the knuckle from the at least one catch arm position in a permit direction, opposite to the block direction, towards the at least one locked arm position.
XXVI. The patient support system as set forth in clause XXV, wherein the biasing force from the biasing element maintains sliding engagement of the distal shuttle end of the shuttle with the knuckle interface surface of the knuckle as movement of the coupler in the block direction from the at least one locked arm position brings the at least one notch into engagement with the shuttle in the at least one catch arm position to inhibit movement in the block direction beyond the at least one catch arm position; and
wherein the at least one notch is shaped to disengage the distal shuttle end of the shuttle in response to force applied by the user to the user interface exceeding the biasing force from the biasing element to permit movement in the block direction beyond the at least one catch arm position.
XXVII. The patient support system as set forth in clause XXV, wherein the patient transport apparatus defines a head end and a foot end spaced longitudinally from the head end; and wherein the coupler is arranged closer to the head end of the patient transport apparatus in the at least one catch arm position than in the at least one locked arm position.
XXVIII. The patient support system as set forth in clause XXVII, wherein the coupler is arranged vertically closer to the intermediate frame in the at least one catch arm position than in the at least one locked arm position.
XXIX. The patient support system as set forth in clause XXV, wherein the knuckle defines at least one seat spaced from the at least one receiver and from the at least one notch;
wherein the plurality of arm positions includes at least one stowed arm position; and
wherein the shuttle is further arranged for movement from the disengaged shuttle position to a stowed shuttle position disposed in engagement with the at least one seat to at least partially limit movement of the coupler relative to the knuckle from the at least one stowed arm position.
XXX. The patient support system as set forth in clause XXIX, wherein the at least one notch is arranged between the at least one seat and the at least one receiver.
XXXI. The patient support system as set forth in clause XXIX, wherein the patient transport apparatus defines a head end and a foot end spaced longitudinally from the head end; and
wherein the coupler is arranged closer to the head end of the patient transport apparatus in the stowed arm position than in the at least one catch arm position.
XXXII. The patient support system as set forth in clause XXXI, wherein the coupler is arranged vertically closer to the intermediate frame in the stowed arm position than in the at least one catch arm position.
XXXIII. The patient support system as set forth in any one of clauses XXV to XXXII, wherein the at least one notch is further defined as a plurality of notches each arranged to engage the shuttle in the catch shuttle position to define a respective catch arm position.
XXXIV. The patient support system as set forth in clause XXXIII, wherein the plurality of notches includes a first notch and a second notch;
wherein engagement of the shuttle with the first notch in the catch shuttle position defines a safety catch arm position; and
wherein engagement of the shuttle with the second notch in the catch shuttle position defines a transfer catch arm position different from the safety catch arm position.
XXXV. The patient support system as set forth in clause XXXIV, wherein the at least one receiver is arranged between the first notch and the second notch.
XXXVI. The patient support system as set forth in clause XXXIV, wherein the patient transport apparatus defines a head end and a foot end spaced longitudinally from the head end; and
wherein the coupler is arranged closer to the head end of the patient transport apparatus in the safety catch arm position than in the transfer catch arm position.
XXXVII. The patient support system as set forth in clause XXXVI, wherein the linkage is arranged extending away from the head end to facilitate patient transfer relative to the patient support deck in the transfer catch arm position.
XXXVIII. The patient support system as set forth in clause XXXVI, wherein the knuckle defines at least one seat spaced from each of the at least one receiver, the first notch, and the second notch;
wherein the plurality of arm positions includes at least one stowed arm position;
wherein the shuttle is further arranged for movement from the disengaged shuttle position to a stowed shuttle position disposed in engagement with the at least one seat to at least partially limit movement of the coupler relative to the knuckle from the at least one stowed arm position;
wherein the coupler is arranged closer to the head end of the patient transport apparatus in the stowed arm position than in the safety catch arm position.
XXXIX. The patient support system as set forth in clause XXXVIII, wherein the at least one receiver of the knuckle is further defined as a plurality of receivers between the first notch and the second notch each arranged to engage the shuttle in the locked shuttle position to define a respective locked arm position.
XL. The patient support system as set forth in clause XXXIX, wherein the plurality of receivers includes a first receiver, a second receiver, and a third receiver;
wherein engagement of the shuttle with the first receiver in the locked shuttle position defines a first locked arm position;
wherein engagement of the shuttle with the second receiver in the locked shuttle position defines a second locked arm position different from the first locked arm position; and
wherein engagement of the shuttle with the third receiver in the locked shuttle position defines a third locked arm position different from the first locked arm position and the second locked arm position.
XLI. The patient support system as set forth in any one of clauses I to XL, wherein the knuckle defines at least one notch spaced from the at least one receiver;
wherein the plurality of arm positions includes at least one catch arm position; and
wherein the shuttle is further arranged for movement from the disengaged shuttle position to a catch shuttle position disposed in engagement with the at least one notch to limit movement of the coupler relative to the knuckle by simultaneously:
   inhibiting movement of the coupler relative to the knuckle from the at least one catch arm position in a block direction away from the at least one locked arm position, and
   permitting movement of the coupler relative to the knuckle from the at least one catch arm position in a permit direction, opposite to the block direction, towards the at least one locked arm position.
XLII. The patient support system as set forth in any one of clauses I to XLI, wherein the knuckle defines at least one seat spaced from the at least one receiver;
wherein the plurality of arm positions includes at least one stowed arm position; and
wherein the shuttle is further arranged for movement from the disengaged shuttle position to a stowed shuttle position disposed in engagement with the at least one seat to at least partially limit movement of the coupler relative to the knuckle from the at least one stowed arm position.
XLIII. The patient support system as set forth in any one of clauses I to XLII, wherein the knuckle defines a knuckle interface surface, the at least one receiver being formed in the knuckle interface surface.
XLIV. The patient support system as set forth in any one of clauses I to XLIII, wherein carrier further includes a biasing element interposed between the shuttle and the selector to urge the shuttle towards the locked shuttle position.
XLV. The patient support system as set forth in any one of clauses I to XLIV, wherein the carrier further includes a user interface operatively attached to the shuttle and arranged for user engagement to move the shuttle away from the locked shuttle position in response to force selectively applied by the user.
XLVI. An arm assembly for use in securing a medical device for concurrent movement with a patient transport apparatus, the arm assembly comprising:
a coupler supporting an interface for releasably securing the medical device;
a knuckle for attaching to the patient transport apparatus, the knuckle defining at least one receiver; and
a carrier supporting the coupler for movement relative to the knuckle between a plurality of arm positions including at least one locked arm position, the carrier including:
   a linkage pivotably coupled to the knuckle and to the coupler to maintain a predetermined alignment of the coupler relative to the patient transport apparatus between the plurality of arm positions, and
   a selector operatively attached to the linkage and supporting a shuttle for selective movement between:
      a locked shuttle position disposed in engagement with the at least one receiver to inhibit movement of the coupler relative to the knuckle between the plurality of arm positions from the at least one locked arm position; and
      a disengaged shuttle position spaced from the at least one receiver to permit movement of the coupler relative to the knuckle between the plurality of arm positions from the at least one locked arm position.
XLVII. The arm assembly as set forth in clause XLVI, wherein the linkage of the carrier includes a brace pivotably coupled to the knuckle and pivotably coupled to the coupler, and a timing link pivotably coupled to the knuckle and pivotably coupled to the coupler.
XLVIII. The arm assembly as set forth in clause XL VII, wherein the timing link extends laterally between a first timing link side and a second timing link side; and
wherein the brace includes a first brace link disposed adjacent to the first timing link side, and a second brace link disposed adjacent to the second timing link side.
XLIX. The arm assembly as set forth in clause XLVIII, wherein the selector includes a selector body operatively attached to each of the first brace link and the second brace link for concurrent movement between the plurality of arm positions.
L. The arm assembly as set forth in clause XLIX, wherein the selector body defines an upper selector wall arranged laterally between the first brace link and the second brace link;
wherein the timing link defines a lower link wall extending laterally between the first timing link side and the second timing link side; and
wherein the upper selector wall and the lower link wall are each shaped to limit contact of external objects with the shuttle.
LI. The arm assembly as set forth in clause L, wherein the timing link includes a first timing link wall defining the first timing link side and extending from the lower link wall to a first timing link edge, and a second timing link wall defining the second timing link side and extending from the lower link wall to a second timing link edge; and
wherein the first brace link and the second brace link are shaped to limit contact of external objects with one or more of the first timing link edge and the second timing link edge.
LII. The arm assembly as set forth in any one of clauses XLVII to LI, wherein the brace and the timing link are shaped to limit contact of external objects with pivoting connections adjacent to one or more of the knuckle and the coupler.
LIII. The arm assembly as set forth in clauses XLVI to LII, wherein the linkage is further defined as a four-bar linkage pivotably coupled to the knuckle and to the coupler and configured to maintain the predetermined alignment of the coupler relative to the patient transport apparatus between the plurality of arm positions.
LIV. The arm assembly as set forth in clause LIII, wherein the predetermined alignment is further defined as substantially parallel alignment.
LV. The arm assembly as set forth in any one of clauses XLVI to LIV, wherein the at least one receiver defines a receiver profile; and
wherein the shuttle includes a shuttle body extending between a distal shuttle end and a proximal shuttle end with a tip disposed adjacent to the distal shuttle end, the tip defining an end profile shaped complimentarily to the receiver profile of the at least one receiver to limit movement of the shuttle relative to the knuckle from the locked shuttle position in a plurality of degrees of freedom.
LVI. The arm assembly as set forth in clause LV, wherein the end profile of the shuttle has a generally frustoconical configuration; and
wherein the plurality of degrees of freedom is further defined as four degrees of freedom.
LVII. The arm assembly as set forth in any one of clauses XLVI to LVI, wherein the at least one receiver of the knuckle is further defined as a plurality of receivers each arranged to engage the shuttle in the locked shuttle position to define a respective locked arm position.
LVIII. The arm assembly as set forth in clause LVII, wherein the plurality of receivers includes a first receiver and a second receiver;
wherein engagement of the shuttle with the first receiver in the locked shuttle position defines a first locked arm position; and
wherein engagement of the shuttle with the second receiver in the locked shuttle position defines a second locked arm position different from the first locked arm position.
LIX. The arm assembly as set forth in clause LVIII, wherein the patient transport apparatus defines a head end and a foot end spaced longitudinally from the head end; and
wherein the coupler is configured to be arranged closer to the head end of the patient transport apparatus in the first locked arm position than in the second locked arm position.
LX. The arm assembly as set forth in clause LIX, wherein the coupler is configured to be arranged vertically closer to the patient transport apparatus in the first locked arm position than in the second locked arm position.
LXI. The arm assembly as set forth in any one of clauses LIX or LX, wherein the plurality of receivers further includes a third receiver; and
wherein engagement of the shuttle with the third receiver in the locked shuttle position defines a third locked arm position different from the first locked arm position and the second locked arm position.
LXII. The arm assembly as set forth in clause LXI, wherein the coupler is configured to be arranged closer to the head end of the patient transport apparatus in the second locked arm position than in the third locked arm position.
LXIII. The arm assembly as set forth in clause LXII, wherein the coupler is configured to be arranged vertically closer to the patient transport apparatus in the third locked arm position than in the second locked arm position.
LXIV. The arm assembly as set forth in any one of clauses LVII to LXIII, wherein the knuckle defines a knuckle interface surface, the plurality of receivers being formed in the knuckle interface surface.
LXV. The arm assembly as set forth in any one of clauses XLVI to LXIV, wherein the selector includes a selector body defining a selector bore arranged along a selector axis, with the shuttle supported for selective movement along the selector axis between the locked shuttle position and the disengaged shuttle position.
LXVI. The arm assembly as set forth in clause LXV, wherein the shuttle includes a shuttle body extending between a distal shuttle end and a proximal shuttle end with a tip disposed adjacent to the distal shuttle end arranged for selective engagement with the at least one receiver in the locked shuttle position;
wherein the selector body extends between a distal selector end and a proximal selector end, the selector bore being arranged adjacent to the distal selector end; and
wherein selective movement of the selector from the locked shuttle position toward the disengaged shuttle position moves the tip of the shuttle towards the proximal selector end.
LXVII. The arm assembly as set forth in clause LXVI, wherein the carrier further includes a biasing element interposed between the shuttle and the selector to urge the shuttle towards the locked shuttle position, and a user interface operatively attached to the shuttle body and arranged for user engagement to move the shuttle away from the locked shuttle position in response to force applied by the user to the user interface.
LXVIII. The arm assembly as set forth in clause LXVII, wherein the knuckle defines a knuckle interface surface, the at least one receiver being formed in the knuckle interface surface; and
wherein the distal shuttle end of the shuttle is disposed in sliding engagement with the knuckle interface surface of the knuckle during movement between the plurality of arm positions in response to biasing force from the biasing element exceeding force applied by the user to the user interface.
LXIX. The arm assembly as set forth in clause LXVIII, wherein the user interface includes a grip arranged for user engagement, with the grip arranged for concurrent movement with the shuttle.
LXX. The arm assembly as set forth in clause LXVIII, wherein the knuckle defines at least one notch spaced from the at least one receiver along the knuckle interface surface;
wherein the plurality of arm positions includes at least one catch arm position; and
wherein the shuttle is further arranged for movement from the disengaged shuttle position to a catch shuttle position disposed in engagement with the at least one notch to limit movement of the coupler relative to the knuckle by simultaneously:
   inhibiting movement of the coupler relative to the knuckle from the at least one catch arm position in a block direction away from the at least one locked arm position, and
   permitting movement of the coupler relative to the knuckle from the at least one catch arm position in a permit direction, opposite to the block direction, towards the at least one locked arm position.
LXXI. The arm assembly as set forth in clause LXX, wherein the biasing force from the biasing element maintains sliding engagement of the distal shuttle end of the shuttle with the knuckle interface surface of the knuckle as movement of the coupler in the block direction from the at least one locked arm position brings the at least one notch into engagement with the shuttle in the at least one catch arm position to inhibit movement in the block direction beyond the at least one catch arm position; and
wherein the at least one notch is shaped to disengage the distal shuttle end of the shuttle in response to force applied by the user to the user interface exceeding the biasing force from the biasing element to permit movement in the block direction beyond the at least one catch arm position.
LXXII. The arm assembly as set forth in clause LXX, wherein the patient transport apparatus defines a head end and a foot end spaced longitudinally from the head end; and
wherein the coupler is configured to be arranged closer to the head end of the patient transport apparatus in the at least one catch arm position than in the at least one locked arm position.
LXXIII. The arm assembly as set forth in clause LXXII, wherein the coupler is configured to be arranged vertically closer to the patient transport apparatus in the at least one catch arm position than in the at least one locked arm position.
LXXIV. The arm assembly as set forth in clause LXX, wherein the knuckle defines at least one seat spaced from the at least one receiver and from the at least one notch;
wherein the plurality of arm positions includes at least one stowed arm position; and
wherein the shuttle is further arranged for movement from the disengaged shuttle position to a stowed shuttle position disposed in engagement with the at least one seat to at least partially limit movement of the coupler relative to the knuckle from the at least one stowed arm position.
LXXV. The arm assembly as set forth in clause LXXIV, wherein the at least one notch is arranged between the at least one seat and the at least one receiver.
LXXVI. The arm assembly as set forth in clause LXXIV, wherein the patient transport apparatus defines a head end and a foot end spaced longitudinally from the head end; and
wherein the coupler is configured to be arranged closer to the head end of the patient transport apparatus in the stowed arm position than in the at least one catch arm position.
LXXVII. The arm assembly as set forth in clause LXXVI, wherein the coupler is configured to be arranged vertically closer to the patient transport apparatus in the stowed arm position than in the at least one catch arm position.
LXXVIII. The arm assembly as set forth in any one of clauses LXX to LXXVII, wherein the at least one notch is further defined as a plurality of notches each arranged to engage the shuttle in the catch shuttle position to define a respective catch arm position.
LXXIX. The arm assembly as set forth in clause LXXVIII, wherein the plurality of notches includes a first notch and a second notch;
wherein engagement of the shuttle with the first notch in the catch shuttle position defines a safety catch arm position; and
wherein engagement of the shuttle with the second notch in the catch shuttle position defines a transfer catch arm position different from the safety catch arm position.
LXXX. The arm assembly as set forth in clause LXXIX, wherein the at least one receiver is arranged between the first notch and the second notch.
LXXXI. The arm assembly as set forth in clause LXXIX, wherein the patient transport apparatus defines a head end and a foot end spaced longitudinally from the head end; and
wherein the coupler is configured to be arranged closer to the head end of the patient transport apparatus in the safety catch arm position than in the transfer catch arm position.
LXXXII. The arm assembly as set forth in clause LXXXI, wherein the linkage is configured to be arranged extending away from the head end to facilitate patient transfer relative to the patient transport apparatus in the transfer catch arm position.
LXXXIII. The arm assembly as set forth in clause LXXXI, wherein the knuckle defines at least one seat spaced from each of the at least one receiver, the first notch, and the second notch;
wherein the plurality of arm positions includes at least one stowed arm position;
wherein the shuttle is further arranged for movement from the disengaged shuttle position to a stowed shuttle position disposed in engagement with the at least one seat to at least partially limit movement of the coupler relative to the knuckle from the at least one stowed arm position;
wherein the coupler is configured to be arranged closer to the head end of the patient transport apparatus in the stowed arm position than in the safety catch arm position.
LXXXIV. The arm assembly as set forth in clause LXXXIII, wherein the at least one receiver of the knuckle is further defined as a plurality of receivers between the first notch and the second notch each arranged to engage the shuttle in the locked shuttle position to define a respective locked arm position.
LXXXV. The arm assembly as set forth in clause LXXXIV, wherein the plurality of receivers includes a first receiver, a second receiver, and a third receiver;
wherein engagement of the shuttle with the first receiver in the locked shuttle position defines a first locked arm position;
wherein engagement of the shuttle with the second receiver in the locked shuttle position defines a second locked arm position different from the first locked arm position; and
wherein engagement of the shuttle with the third receiver in the locked shuttle position defines a third locked arm position different from the first locked arm position and the second locked arm position.
LXXXVI. The arm assembly as set forth in any one of clauses XLVI to LXXXV, wherein the knuckle defines at least one notch spaced from the at least one receiver;
wherein the plurality of arm positions includes at least one catch arm position; and
wherein the shuttle is further arranged for movement from the disengaged shuttle position to a catch shuttle position disposed in engagement with the at least one notch to limit movement of the coupler relative to the knuckle by simultaneously:
   inhibiting movement of the coupler relative to the knuckle from the at least one catch arm position in a block direction away from the at least one locked arm position, and
   permitting movement of the coupler relative to the knuckle from the at least one catch arm position in a permit direction, opposite to the block direction, towards the at least one locked arm position.
LXXXVII. The arm assembly as set forth in any one of clauses XL VI to LXXXVI, wherein the knuckle defines at least one seat spaced from the at least one receiver;
wherein the plurality of arm positions includes at least one stowed arm position; and
wherein the shuttle is further arranged for movement from the disengaged shuttle position to a stowed shuttle position disposed in engagement with the at least one seat to at least partially limit movement of the coupler relative to the knuckle from the at least one stowed arm position.
LXXXVIII. The arm assembly as set forth in any one of clauses XLVI to LXXXVII, wherein the knuckle defines a knuckle interface surface, the at least one receiver being formed in the knuckle interface surface.
LXXXIX. The arm assembly as set forth in any one of clauses XLVI to LXXXVIII, wherein carrier further includes a biasing element interposed between the shuttle and the selector to urge the shuttle towards the locked shuttle position.
XC. The arm assembly as set forth in any one of clauses XLVI to LXXXIX, wherein the carrier further includes a user interface operatively attached to the shuttle and arranged for user engagement to move the shuttle away from the locked shuttle position in response to force selectively applied by the user.

1. A patient support system for concurrently transporting a patient and a medical device, the patient support system comprising:
a patient transport apparatus including a base arranged for movement along floor surfaces, and an intermediate frame coupled to the base and defining a patient support deck; and
an arm assembly including:
a coupler supporting an interface for releasably securing the medical device,
a knuckle operatively attached to the intermediate frame of the patient transport apparatus and defining at least one receiver, and
a carrier supporting the coupler for movement relative to the knuckle between a plurality of arm positions including at least one locked arm position, the carrier including:
a linkage pivotably coupled to the knuckle and to the coupler to maintain a predetermined alignment of the coupler relative to the intermediate frame between the plurality of arm positions, and
a selector operatively attached to the linkage and supporting a shuttle for selective movement between:
a locked shuttle position disposed in engagement with the at least one receiver to inhibit movement of the coupler relative to the knuckle between the plurality of arm positions from the at least one locked arm position; and
a disengaged shuttle position spaced from the at least one receiver to permit movement of the coupler relative to the knuckle between the plurality of arm positions from the at least one locked arm position.

2. The patient support system as set forth in claim 1, wherein the linkage of the carrier includes a brace pivotably coupled to the knuckle and pivotably coupled to the coupler, and a timing link pivotably coupled to the knuckle and pivotably coupled to the coupler.

3. The patient support system as set forth in claim 2, wherein the timing link extends laterally between a first timing link side and a second timing link side; and
wherein the brace includes a first brace link disposed adjacent to the first timing link side, and a second brace link disposed adjacent to the second timing link side.

4. The patient support system as set forth in claim 3, wherein the selector includes a selector body operatively attached to each of the first brace link and the second brace link for concurrent movement between the plurality of arm positions.

5. The patient support system as set forth in claim 4, wherein the selector body defines an upper selector wall arranged laterally between the first brace link and the second brace link;
wherein the timing link defines a lower link wall extending laterally between the first timing link side and the second timing link side; and
wherein the upper selector wall and the lower link wall are each shaped to limit contact of external objects with the shuttle.

6. The patient support system as set forth in claim 5, wherein the timing link includes a first timing link wall defining the first timing link side and extending from the lower link wall to a first timing link edge, and a second timing link wall defining the second timing link side and extending from the lower link wall to a second timing link edge; and
wherein the first brace link and the second brace link are shaped to limit contact of external objects with one or more of the first timing link edge and the second timing link edge.

7. The patient support system as set forth in claim 2, wherein the brace and the timing link are shaped to limit contact of external objects with pivoting connections adjacent to one or more of the knuckle and the coupler.

8. The patient support system as set forth in claim 1, wherein the linkage is further defined as a four-bar linkage pivotably coupled to the knuckle and to the coupler to maintain the predetermined alignment of the coupler relative to the intermediate frame between the plurality of arm positions.

9. (canceled)

10. The patient support system as set forth in claim 1, wherein the at least one receiver defines a receiver profile;
wherein the shuttle includes a shuttle body extending between a distal shuttle end and a proximal shuttle end with a tip disposed adjacent to the distal shuttle end, the tip defining an end profile shaped complimentarily to the receiver profile of the at least one receiver to limit movement of the shuttle relative to the knuckle from the locked shuttle position in a plurality of degrees of freedom;
wherein the end profile of the shuttle has a generally frustoconical configuration; and
wherein the plurality of degrees of freedom is further defined as four degrees of freedom.

11. (canceled)

12. The patient support system as set forth in claim 1, wherein the at least one receiver of the knuckle is further defined as a plurality of receivers each arranged to engage the shuttle in the locked shuttle position to define a respective locked arm position;
wherein the plurality of receivers includes a first receiver and a second receiver;
wherein engagement of the shuttle with the first receiver in the locked shuttle position defines a first locked arm position; ad
wherein engagement of the shuttle with the second receiver in the locked shuttle position defines a second locked arm position different from the first locked arm position;
wherein the patient transport apparatus defines a head end and a foot end spaced longitudinally from the head end; and
wherein the coupler is arranged closer to the head end of the patient transport apparatus in the first locked arm position than in the second locked arm position;
wherein the plurality of receivers further includes a third receiver;
wherein engagement of the shuttle with the third receiver in the locked shuttle position defines a third locked arm position different from the first locked arm position and the second locked arm position;
wherein the coupler is arranged closer to the head end of the patient transport apparatus in the second locked arm position than in the third locked arm position; and
wherein the coupler is arranged vertically closer to the intermediate frame in the third locked arm position than in the second locked arm position.

13. (canceled)

14. (canceled)

15. (canceled)

16. (canceled)

17. (canceled)

18. (canceled)

19. (canceled)

20. The patient support system as set forth in claim 1, wherein the selector includes a selector body defining a selector bore arranged along a selector axis, with the shuttle supported for selective movement along the selector axis between the locked shuttle position and the disengaged shuttle position;
wherein the shuttle includes a shuttle body extending between a distal shuttle end and a proximal shuttle end with a tip disposed adjacent to the distal shuttle end arranged for selective engagement with the at least one receiver in the locked shuttle position;
wherein the selector body extends between a distal selector end and a proximal selector end, the selector bore being arranged adjacent to the distal selector end;
wherein selective movement of the selector from the locked shuttle position toward the disengaged shuttle position moves the tip of the shuttle towards the proximal selector end.
wherein carrier further includes a biasing element interposed between the shuttle and the selector to urge the shuttle towards the locked shuttle position, and a user interface operatively attached to the shuttle body and arranged for user engagement to move the shuttle away from the locked shuttle position in response to force applied by the user to the user interface.
wherein the knuckle defines a knuckle interface surface, the at least one receiver being formed in the knuckle interface surface; and
wherein the distal shuttle end of the shuttle is disposed in sliding engagement with the knuckle interface surface of the knuckle during movement between the plurality of arm positions in response to biasing force from the biasing element exceeding force applied by the user to the user interface.

21. (canceled)

22. (canceled)

23. (canceled)

24. (canceled)

25. The patient support system as set forth in claim 20, wherein the knuckle defines at least one notch spaced from the at least one receiver along the knuckle interface surface;
wherein the plurality of arm positions includes at least one catch arm position; and
wherein the shuttle is further arranged for movement from the disengaged shuttle position to a catch shuttle position disposed in engagement with the at least one notch to limit movement of the coupler relative to the knuckle by simultaneously:
inhibiting movement of the coupler relative to the knuckle from the at least one catch arm position in a block direction away from the at least one locked arm position, and
permitting movement of the coupler relative to the knuckle from the at least one catch arm position in a permit direction, opposite to the block direction, towards the at least one locked arm position.

26. The patient support system as set forth in claim 25, wherein the biasing force from the biasing element maintains sliding engagement of the distal shuttle end of the shuttle with the knuckle interface surface of the knuckle as movement of the coupler in the block direction from the at least one locked arm position brings the at least one notch into engagement with the shuttle in the at least one catch arm position to inhibit movement in the block direction beyond the at least one catch arm position; and
wherein the at least one notch is shaped to disengage the distal shuttle end of the shuttle in response to force applied by the user to the user interface exceeding the biasing force from the biasing element to permit movement in the block direction beyond the at least one catch arm position.

27. The patient support system as set forth in claim 25, wherein the patient transport apparatus defines a head end and a foot end spaced longitudinally from the head end;
wherein the coupler is arranged closer to the head end of the patient transport apparatus in the at least one catch arm position than in the at least one locked arm position; and
wherein the coupler is arranged vertically closer to the intermediate frame in the at least one catch arm position than in the at least one locked arm position.

28. (canceled)

29. The patient support system as set forth in claim 25, wherein the knuckle defines at least one seat spaced from the at least one receiver and from the at least one notch;
wherein the plurality of arm positions includes at least one stowed arm position; and
wherein the shuttle is further arranged for movement from the disengaged shuttle position to a stowed shuttle position disposed in engagement with the at least one seat to at least partially limit movement of the coupler relative to the knuckle from the at least one stowed arm position.

30. The patient support system as set forth in claim 29, wherein the at least one notch is arranged between the at least one seat and the at least one receiver.

31. The patient support system as set forth in claim 29, wherein the patient transport apparatus defines a head end and a foot end spaced longitudinally from the head end;
wherein the coupler is arranged closer to the head end of the patient transport apparatus in the stowed arm position than in the at least one catch arm position; and
wherein the coupler is arranged vertically closer to the intermediate frame in the stowed arm position than in the at least one catch arm position.

32. (canceled)

33. The patient support system as set forth in claim 25, wherein the at least one notch is further defined as a plurality of notches each arranged to engage the shuttle in the catch shuttle position to define a respective catch arm position;
wherein the plurality of notches includes a first notch and a second notch;
wherein engagement of the shuttle with the first notch in the catch shuttle position defines a safety catch arm position;
wherein engagement of the shuttle with the second notch in the catch shuttle position defines a transfer catch arm position different from the safety catch arm position;
wherein the patient transport apparatus defines a head end and a foot end spaced longitudinally from the head end; and
wherein the coupler is arranged closer to the head end of the patient transport apparatus in the safety catch arm position than in the transfer catch arm position.

34. (canceled)

35. (canceled)

36. (canceled)

37. (canceled)

38. The patient support system as set forth in claim 33, wherein the knuckle defines at least one seat spaced from each of the at least one receiver, the first notch, and the second notch;
wherein the plurality of arm positions includes at least one stowed arm position;
wherein the shuttle is further arranged for movement from the disengaged shuttle position to a stowed shuttle position disposed in engagement with the at least one seat to at least partially limit movement of the coupler relative to the knuckle from the at least one stowed arm position;
wherein the coupler is arranged closer to the head end of the patient transport apparatus in the stowed arm position than in the safety catch arm position;
wherein the at least one receiver of the knuckle is further defined as a plurality of receivers between the first notch and the second notch each arranged to engage the shuttle in the locked shuttle position to define a respective locked arm position.
the plurality of receivers includes a first receiver, a second receiver, and a third receiver;
wherein engagement of the shuttle with the first receiver in the locked shuttle position defines a first locked arm position;
wherein engagement of the shuttle with the second receiver in the locked shuttle position defines a second locked arm position different from the first locked arm position; and
wherein engagement of the shuttle with the third receiver in the locked shuttle position defines a third locked arm position different from the first locked arm position and the second locked arm position.

39. (canceled)

40. (canceled)

41. (canceled)

42. The patient support system as set forth in claim 1, wherein the knuckle defines at least one seat spaced from the at least one receiver;
wherein the plurality of arm positions includes at least one stowed arm position; and
wherein the shuttle is further arranged for movement from the disengaged shuttle position to a stowed shuttle position disposed in engagement with the at least one seat to at least partially limit movement of the coupler relative to the knuckle from the at least one stowed arm position.

43. (canceled)

44. (canceled)

45. (canceled)

46. (canceled)

47. (canceled)
